(19) United States
(12) Patent Application Publication
(10) Pub. No.: US 2010/0280676 A1
(43) Pub. Date: Nov. 4, 2010

(54) Multi-functional Bi-directional Communication and Bias Power Architecture for Power Supply Control

(76) Inventors: Gus Charles PABON, Cupertino, CA (US); Kevin David Jones, Hayward, CA (US); Chia Yin Ko, Union City, CA (US); George Lagui, Walnut Creek, CA (US); Parag Mody, Oakland, CA (US); Mark Edward Walsh, Berkeley, CA (US); Huijie Yu, Santa Clara, CA (US); Bogdan Tudor Bucheru, Tucson, AZ (US); Arian Jansen, Lake Fores, CA (US)

Correspondence Address: Reed Smith LLP, P.O. Box 488, Pittsburgh, PA, 15230-0488, US

(21) Appl. No.: 12/772,165

(22) Filed: Apr. 30, 2010

Related U.S. Application Data
(60) Provisional application No. 61/174,454, filed on Apr. 30, 2009.

(51) Int. Cl. G06F 1/26

(52) U.S. Cl. 700/295

(57) ABSTRACT

Connecting a load device to a power supply is described. A connection to a load device is detected on a communication link, where the load device is in a first power state. In response to detecting the connection to the load device, a bias power source is enabled to supply bias power on the communication link to the load device. Power information of the load device is received over the communication link. Power is supplied to the load device, based on the power information, to place the load device in a second power state.

### CROSS-REFERENCE TO RELATED APPLICATIONS

The present application is a utility patent application related to and claiming priority to U.S. provisional application Ser. No. 61/174,454 filed Apr. 30, 2009, the disclosure of which is incorporated herein by reference.

### TECHNICAL FIELD

The disclosed embodiments relate generally to power controls, power supplies, and to a medium for communication between two electronic systems; more particularly, to a multi-functional, one-wire communication between a multi-port power supply capable of receiving digital communications and one or more devices to be powered by the power supply.

### BACKGROUND

From laptop computers and personal digital assistants to multimedia players and mobile phones, a wide variety of electronic devices require power from a power source, and rely on communication between two electronic systems to optimize their operation and collaboration. These electronic devices come with a wide variety of power supplies, sometimes referred to as “wall warts,” “power bricks,” or “power adapters.” Unfortunately, these power supplies are often specific to the device type, device manufacturer, and/or device product line, and are therefore incompatible with each other. If a user loses a power supply for a device, the power supply of another device generally cannot be used as a substitute. This causes many problems. Travel is made more inconvenient by the prospect of having to bring multiple power supplies for various portable devices. A device may be damaged and/or its useful life shortened if the wrong power supply is used. Furthermore, as devices become obsolete and are discarded by users, the power supplies for the devices may be discarded as well because users often do not have other devices that are compatible with these power supplies.

Power supply hubs having multiple ports are practical for connecting multiple devices to a power supply. However, when a device is plugged in, the hub uses intelligent communications to determine the right power to supply to the respective device. The power requirements can be communicated across a wire connected to the devices, but in order to have communication the wire between the devices needs to be activated by one of the connected device systems.

Communication between two electronic systems is also used to optimize operation and power consumption of the connecting device. Efforts have been made to improve communication modes in order to provide more sophisticated power delivery. These efforts include driving microprocessors on both sides of the power link once power is made available, and using low power processors on the load device. This improves power delivery, but still has drawbacks with respect to enabling power saving modes, particularly when microprocessors and/or other communication components are powered down. Current device processors cannot engage in the initial communication necessary to establish the appropriate level of power when the device is powered down or in a power saving mode. The entire device must be powered up in order for power communication to occur. In other words, powering up a device requires communication to exchange power requirements, but in order to have the communication the device needs power to turn on. There currently is no way to power devices back up from a powered down state without manual or external intervention, or unless the device is equipped with a battery source. However, even in the case where batteries arc included, additional wiring is necessary, excess power is consumed, and delays result as the power supply determines efficient power levels for one or more connected devices.

Electronic devices also utilize multiple wires to receive power and communicate to other devices. When multiple electronic devices arc connected to a multi-port power supply hub, each device requires a positive-power-line, a negative (circuit return) power-line; and additional wiring for establishing data communication between two or more devices. Generally, users of these devices prefer thinner, lighter and more flexible cable harness by minimizing the number of wires in the harness that connects devices.

### BRIEF DESCRIPTION OF THE DRAWINGS

For a better understanding of the aforementioned embodiments of the invention as well as additional embodiments thereof, reference should be made to the description of embodiments below, in conjunction with the following drawings in which like reference numerals refer to corresponding parts throughout the figures.

FIG. 1 is a block diagram illustrating a power supply coupled to a power source and electronic devices in accordance with some embodiments.

FIG. 2 is a schematic illustrating a multi-port power supply coupled to devices in accordance with some embodiments.

FIG. 3 is a block diagram illustrating a multi-port power supply capable of converting an AC power to a DC power in accordance with some embodiments.

FIG. 4 is a block diagram illustrating a device connected to a power supply in accordance with some embodiments.

FIG. 5A is a block diagram illustrating a load device coupled to a power supply hub in accordance with some embodiments.

FIG. 5B is a block diagram of a power supply hub in accordance with some embodiments.

FIG. 5C a block diagram of a multiport power supply hub in accordance with some embodiments.

FIG. 5D is a block diagram illustrating a multiport power supply huh having multiple secondary processors in accordance with some embodiments.

FIG. 6A is a schematic illustrating a load device coupled to a power supply hub in accordance with certain embodiments.

FIG. 6B is a schematic illustrating a load device coupled to a power supply hub in accordance with another embodiment.

FIG. 6C is a schematic illustrating the circuitry of a supply hub and load device in accordance with some other embodiments.

FIG. 7 is a signal diagram illustrating the operation of the schematic of FIGS. 5 and 6 in accordance with some embodiments.

FIGS. 8A-D are block diagrams illustrating various types of load devices to couple to a power supply in accordance with some embodiments.

FIG. 9A is a block diagram illustrating a load device coupled to a power supply hub in accordance with another embodiment.

FIG. 9B is a block diagram illustrating a load device coupled to a single port power supply hub in accordance with another embodiment.

FIG. 10 is a flow diagram illustrating a process of supplying power by a power supply to a connected device in accordance with some embodiments.

FIG. 11 is a flow diagram illustrating a process of supplying power to a connected device in accordance with other embodiments.

FIG. 12 is a flow diagram illustrating a process of supplying power to a connected device in accordance with some other embodiments.

FIG. 13 is a flow diagram illustrating a process for connecting a power supply to a load device in accordance with some other embodiments.

FIG. 14 is a flow diagram illustrating a process 1400 for providing power to one or more load devices.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the invention to these particular embodiments. In other instances, well-known methods, procedures, components, and circuits have not been described in detail so as not to unnecessarily obscure aspects of the embodiments.

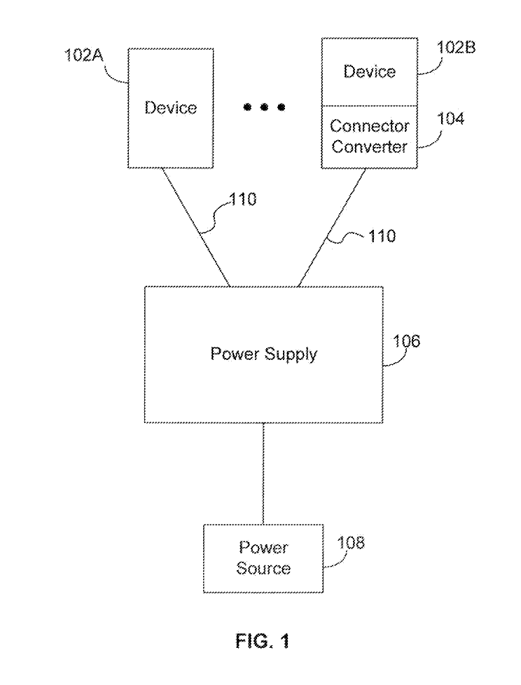

FIG. 1 illustrates a power supply 106 coupled to a power source 108 and devices 102 (e.g. 102A, 102B) in accordance with some embodiments. The power supply 106 may be electrically coupled to the power source 108, from which the power supply 106 receives electrical power to be supplied to devices 102. The power source may be a source of alternating current (AC) or direct current (DC) voltage. In some embodiments, the power source is a power outlet, such as a wall outlet. The power outlet may provide AC voltage, which is typically 110V in the United States and may be at other voltages outside the United States and/or depending upon local requirements. In some other embodiments, the power source is an outlet in an airplane armrest or in an automobile, such as a cigarette lighter socket, which provides 12V DC voltage. In further other embodiments, the power source is a motor, generator, battery, and so on that provides electricity. Depending on the particular embodiment, the power supply 106 may be configured for coupling to only a DC power source, only an AC power source, or either a DC or AC power source. The power supply 106 may be coupled to the power source 108 via a power cord, cable, or the like.

The power supply 106 may be electrically coupled to one or more devices 102. The devices 102 may include any of a variety of electronic devices, including but not limited to consumer electronic devices, computer devices and peripherals (e.g., desktop computers, laptop computers, printers, scanners, monitors, laptop docking stations, and so on), portable hand-held devices (e.g., video players, still image players, game players, other portable media players, music recorders, video recorders, cameras, other media recorders, radios, medical equipment, calculators, cellular telephones, smart phones, other wireless communication devices, personal digital assistants, programmable remote controls, pagers and so on), small appliances, battery chargers, and power tools. Depending on the particular embodiment, if there are multiple devices 102 coupled to the power supply 106, the devices 102 may be coupled to the power supply 106 independently or in series or in parallel.

In some embodiments, the power supply 106 is a standalone unit, external to and distinct from devices to be powered by the power supply 106. The external power supply 106 may be electrically coupled to one or more devices via a power connection 110 (e.g., power cords, cables, induction, or other known ways of transmitting power). In some embodiments, both the power supply 106 and a device 102A conform to a common connector or interface standard; the power connection 110 coupling the power supply 106 to a given device, such as the device 102A, includes standardized connectors on one or both ends of the connection, and may, in some embodiments, be non-detachably affixed to the power supply 106. Device 102A may be designed to use the standardized connector and be coupled to the power supply 106 via the power connection 110. In other words, the power supply 106 serves as a universal power supply to any device that is designed to include the standardized connector.

In some embodiments, the power connection 110 may be a cable cord or harness that comprises a set of power lines and a single data communication wire. The single data communication wire may be capable of multiple functions, including the ability to provide bias power to drive a load processor (not shown) for communicating power requirements at initial power up to then enable full communication and full power to the respectively connected device. The small bias power activates the load processor without having to wait for power to the rest of the device 102. In some embodiments, the power supply 106 may detect connection and disconnection of devices 102 over the single data communication wire in the power connection 110 without waiting for the device 102 itself to power up or power down, or without waiting for some power up/down signal from the device 102. Instead of using *a bulky multi-wire bundle to achieve multiple power functions, a thinner cable having a single communication line may be used as the power connection 110. The thinner cable allows for multiple power saving functions with only a single data communication line and a single set of power lines, embodiments of which will be further described in sections below. A multi-functional single data communication line in a thinner cord provides cost-saving benefits, is smaller and more convenient to the user, and allows for respective connectors to be as small as possible, with less wiring, less pins, a smaller size.

In some other embodiments, the power supply 106 and a device 102B uses different types of power connectors (not shown). For example, a device that is not designed to use the standardized connector (e.g., an older device) may have a power connector that is device or manufacturer specific and not conforming to the standard that is used by the power supply 106. In such embodiments, the power supply 106 may be coupled directly to the device 102B via a cord (not shown) that includes the standardized connector on one end and a device or manufacturer specific connector on the other end. In other words, the cord is customized to the connector on the device 102B because at least one connector on the cord is device or manufacturer specific. The cord may be a multi-functional harness or cord, as will be further described in later sections. Alternatively, an attachment, such as a dongle, may be coupled to the device 102B. The attachment “converts” the connector on the device 102B to the standardized connector utilized by the power supply 106, thereby allowing coupling of the power supply 106 and the device 102B via a cord having the standardized connector on both ends. An example of such a connector converter 104 is shown in FIG. 1.

In some other embodiments, the power supply 106 may be integrated with the device 102 to be powered by the power supply 106. For example, the power supply 106 may be the internal power supply of a desktop computer, an audio/visual receiver or preamplifier, a power strip or surge protector, an uninterruptible power supply, or something similar. Furthermore, in some embodiments, other external devices may be electrically coupled to the power supply 106 that is integrated into another device. For example, returning to the example of the power supply 106 integrated with a desktop computer, other external devices may be coupled to the power supply that is integrated with the desktop computer. Other external devices may include, but is not limited to, computer devices and peripherals (e.g., laptop computers, printers, scanners, monitors, laptop docking stations, and so on), portable hand-held devices coupled to the desktop computer (e.g., video players, still image players, game players, other portable media players, music recorders, video recorders, cameras, other media recorders, radios, medical equipment, calculators, cellular telephones, smart phones, other wireless communication devices, personal digital assistants, programmable remote controls, pagers and so on), and battery chargers. The integrated power supply may supply power to the desktop computers as well as to the external devices coupled to the desktop computer. The integrated power supply may be coupled to the external devices via a thin one-wire cable enhanced with power-saving features as will be further described below.

The power supply 106 may come in a variety of sizes. For example, the power supply 106 may be implemented in a relatively small size for ease of portability and travel convenience. The power supply 106 may also be implemented as a relatively larger power supply size for home, office, or industrial use.

As described above, devices 102 that may be electrically coupled to the power supply 106 may encompass a variety of electronic devices, including but not limited to consumer electronic devices (e.g., mobile phones, cordless phones, smart phones, other wireless communication devices, baby monitors, televisions, digital cameras, camcorders, MP3 or video players, game players, CD or DVD players, VCRs, personal digital assistants (PDAs), other media players, music recorders, video recorders, other media recorders, radios, medical equipment, calculators, programmable remote controls, pagers, and other portable handheld devices), computer devices (e.g., computers, network routers, non-volatile storage, printers, monitors, scanners), small appliances, battery chargers, and power tools. Some of these devices may include a battery or batteries and some may not. The battery (or batteries) may be rechargeable or non-rechargeable. Examples of rechargeable battery technologies include lithium-ion batteries, nickel cadmium batteries, and nickel metal hydride batteries. Examples of non-rechargeable battery technologies include alkaline and lithium batteries. For a device that does not have a battery or that has non-rechargeable batteries, the power supplied by the power supply 106 merely powers the device for operation. For a device that has a rechargeable battery, the power supplied by the power supply 106 powers the device for operation and/or recharges the battery. As it is known in the art, different devices and batteries have different power requirements for operation and/or battery charging. Thus, the power supply 106 needs to know the power requirements of the devices 102, in order to supply the proper amount of power.

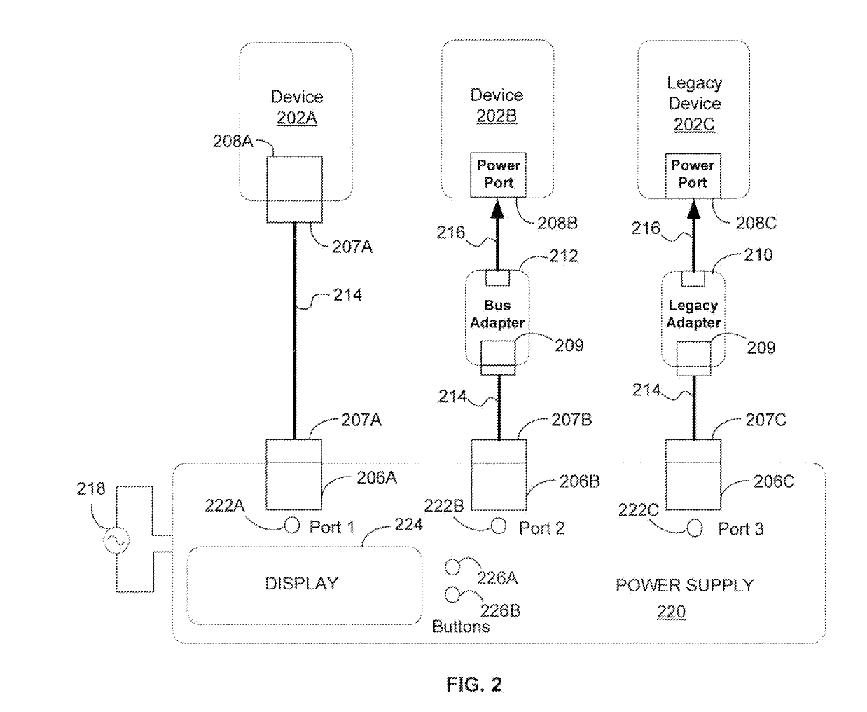

FIG. 2 illustrates a multi-port power supply 220 coupled to devices 202 in accordance with some embodiments. Power supply 220 includes an input for receiving power from a power source 218. Power supply 220 has multiple output ports 206 (e.g., 206A, 206B, and 206C). Output ports 206 can be ports to accommodate any combination of connectors 207 (e.g., 207A, 207B, and 207C), including but not limited to any combination of plugs, receptacles, sockets, magnetic power connectors, non-detachable cables, and so on. In one embodiment, the output ports 206 include a receptacle for receiving multi-purpose power connectors 207. In another embodiment, one or more cables 214 are non-detachably fixed to one or more output ports 206. Power supply 220 may also include a user interface for interaction with a user. In some embodiments, the user interface comprises a status light 222 (e.g., 222A, 222B, and 222C) associated with each output port 206 that may indicate whether a device 202 is being powered, whether the device 202 is being provided reduced power, or other statuses of power supply 220 or devices 202 connected to the power supply 220. Status lights 222 can indicate one or more statuses by blinking, changing colors, or the like. The user interface of power supply 220 may also include display 224, which may be an LCD screen, an LED, or an OLED display for displaying information to a user. In some embodiments, status information can be displayed on display 224 in addition to or in place of status lights 222. For example, the background color of display 224 could change colors or blink based on the status of the devices 202 or the power supply 220. In other embodiments, where device 202 includes a display (not shown), power supply 220 may instruct device 202 to display certain information on the display of device 202. The display of device 202 may be an LCD screen, an LED, or an OLED display.

Furthermore, additional information about power supply 220 may be displayed on display 224. The user interface of power supply 220 may also include one or more input components so that a user can interact with power supply 220. Examples of one or more input components include buttons 226 (e.g., 226A and 226B). Buttons 226 may be used in connection with display 224 to allow a user to access information about power supply 220, any of the attached devices 202, and/or to program or otherwise interact with power supply 220. For example, display 224 may provide information about the operating mode or charge mode of power supply 220, current load and capacity information of output ports 206 and/or of power supply 220, the current time, and so on. Display 224 may also show information about the devices 202 currently and or previously connected to power supply 220 such as, device identification information, device power requirements, device battery identification information, device battery condition information, and so on. When a battery in device 202 is being charged, display 224 may indicate the amount of time left until the battery is fully charged.

Buttons 226 may also be used to set the operating mode or the charge mode of power supply 220. As shown by buttons 226, it is contemplated that multiple buttons or other control interfaces could be used, for example, to allow a user to more easily interact with power supply 220 or to provide access to more features or information. For example, the user interface of power supply 220 may include multiple control menus each with one or more control functions. In some embodiments, other input components are used in place of or in conjunction with buttons 226. For example, display 224 could be a touch screen and thus allow input from a user. Other forms of input components include but are not limited to a scroll wheel, dial, knob, joystick, trackball, and 5-way switch.

In some embodiments, devices 202 may use standardized connector 207A to be coupled to the power supply 220 via cable 214 having the standardized connectors 207A. By using standardized connectors 207A, the power supply 220 can serve as a universal power supply 220 to any device that is designed to include a standardized plug, receptacle or other such connectors. Standardized connector 207A may be any one of, but is not limited to, plugs, receptacles, sockets, magnetic power connectors, non-detachable cables, other universal connectors, and so on. In other embodiments, the power supply 220 and devices 202 may use different types of power connectors. For example, devices 202 that are not designed to use the standard connector 207A may have a device- or manufacture-specific connector that connects to a device- or manufacture-specific power port 208B. The device- or manufacture-specific connector/port may not conform to the standard that is used by the power supply 220. In other embodiments, the device 202B may be connected to the power supply 220 via a bus adapter 212 to convert the connector at port 208B on the device 202B to the standardized connector 207B utilized by the power supply 220. On one end, the bus adapter 212 is coupled to the device 202B by a power cord 216. The power cord 216 may be directly coupled to the device 202B or may include device- or manufacture-specific connectors to connect to the device 202B at the power port 208B. On the other end, the bus adapter 212 is coupled to the power supply 220 by cable 214 having connectors 207B, 209 that conform to the standard used by the power supply 220. In other words, the bus adapter 212 may contain both standard connectors and device-specific connectors, thereby allowing the power supply 220 and the device 202B to be connected by one or more cables 214, 216.

In some embodiments, the device- or manufacture-specific connector/port may be for a legacy device 202C with a legacy port 208C. The legacy port 208C may receive a legacy connector (not shown) to connect to the power supply 220 via cable 214 having a connector 207C on the other end that is different from the legacy connector. In other embodiments, the legacy device 202C may be connected to the power supply 220 via a legacy adapter 210 to convert the connector on the legacy device 202C to the standardized connector utilized by the power supply 220. Similar to the bus adapter 212, the legacy adapter 210 may use a combination of standard and device-specific connectors to connect the legacy device 202C to the power supply 220 via cables 214, 216.

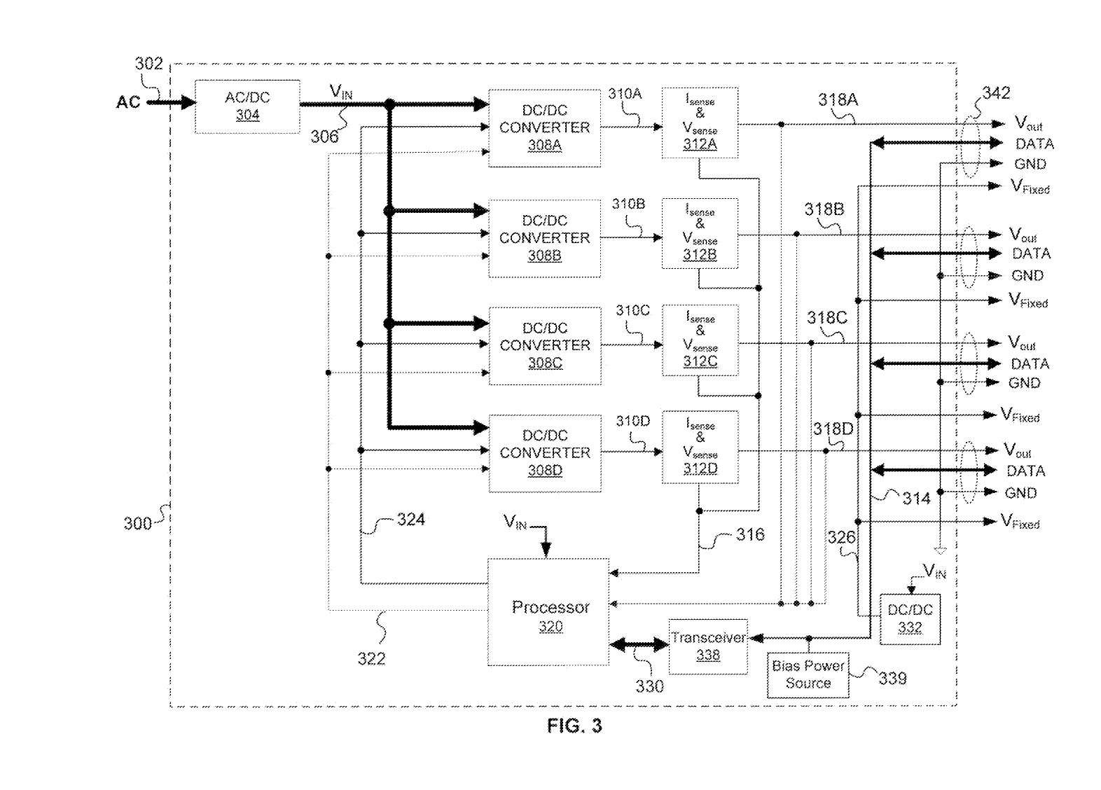

FIG. 3 illustrates a power supply 300 that converts an AC power to a DC power to supply power to devices, such as device 102, 202 of FIGS. 1 and 2, in accordance with some embodiments. The power supply 300 acquires information regarding power requirements of a device, such as device 102, 202, to be powered by the power supply 300 via digital communications bus 314 between the power supply 300 and one or more devices (not shown) connected to the power supply 300. Based on the power information, the power supply 300 supplies power to the one or more devices, such as devices 102, 202, in accordance with the specified power requirements.

The power supply 300 may receive either a DC input voltage (e.g., 12 V from an automobile cigar lighter socket) or an AC input voltage (e.g., 110 V or a 220 V from a wall outlet) from a power source 108 of FIG. 1 via electrical bus 302. Either input voltage may be fed through surge protection circuitry/components (not shown) in the power supply 300. The (optional) surge protection circuitry or components, which are well known in the art, may be included in the power supply 300 for protection against power surges or electrical spikes. Voltage from an AC source may also be fed through an AC/DC converter 304. The AC/DC Converter 304 converts voltage from the AC source to a DC voltage V_{IN} for use by the circuitry of the power supply 300 to generate power for devices such as devices 102, 202.

The input voltage V_{IN} may be fed from the AC/DC converter 304 through an electrical bus 306 to various circuitries within the power supply 300. The circuitries within the power supply 300 may include a DC/DC converter 308 and a current or voltage sense circuitry 312, which are configured to supply a predefined voltage to devices such as device 102, 202 via conductor lines 310, 318. In some embodiments, the DC/DC converter 308 may be fully programmable and configured to supply predefined voltages that are different from device to device, or it may supply different voltages at various stages of powering device 102, 202 (e.g., full power, partial power, power save mode, power up mode, power down mode, and so on). The programmable DC/DC converter 308 may vary at any time, and may follow a request from the device 102, 202 or an electrical event such as the device 102, 202 disconnecting from the power supply 300. In some embodiments, the DC/DC converter 308 generates a fixed voltage that does not change, but may be controlled to turn on and off. In some embodiments, the current and/or voltage sense circuitry 312 regulates levels of the voltage (predefined or fixed) from the DC/DC converter 308 by providing feedback to processing circuitry, such as processor 320, and making adjustments to the final output voltage to provide a constant voltage or a constant current via conductor line 318 to connected devices such as device 102, 202.

In some embodiments, the DC/DC converter 308 and the sense circuitry 312 may be regulated by a processor 320. If the DC/DC converter 308 and the sense circuitry 312 are programmable, they may be digitally controlled power sources that can provide adjustable output values, e.g., voltage or current, through the use of feedback circuitry as shown by electrical bus 316 and reference V_{IN}. For example, after a digital reference is specified, if the output voltage is too low a controlling element (such as the DC/DC converter 308 or the sense circuit 312) is instructed to increase the voltage to adjust the output. Conversely, if the output voltage is higher than the specified digital reference, the controlling element is instructed to reduce the voltage at the output. The processor 320 may include microprocessors, memory, and other components (not shown) to store and process values, feedback information and instructions for configuring the power supply 300. The processor 320 sends and receives digital communications from devices such as device 102, 202 and configures the power supply to provide the required parameters such as voltage and current values. The processor 320 sends and receives digital communication from devices, such as device 102, 202, via a communication bus 314. The processor 320 receives and processes digital messages from the devices such as device 102, 202. In some embodiments, the processing of a digital message from device 102, 202 includes error detection, inspecting the contents of the message, and, based on the contents, executing further instructions. Based on the content of the messages, the processor 320 executes instructions to send responses to the devices such as device 102, 202 via the communication bus 314 and/or provide voltage or current values to the configure the DC/DC converter 308.

In some embodiments, the processor 320 includes memory (not shown) to store a database of predefined power profiles. A power profile is a predefined set of data that specifies power requirements, or more particularly, a predefined combination of power requirement parameters. In some embodiments, a power profile includes one or more of the following: a constant voltage value, a constant current value, a wattage value, an upper limit current value, and a battery type. The power profiles may be organized as a lookup table in memory, with each power profile referenced by an identifier. Device 102, 202 may communicate, in a digital message, the identifier of the desired profile to the processor 320. The processor 320 retrieves from memory the power profile corresponding to the identifier provided by the device 102, 202. Parameters in the retrieved power profile may be used to configure circuits 308, 312.

In further other embodiments, memory may include a database of identifiers associated with known vendors of devices or a database of identifiers of devices. Furthermore, in alternative embodiments, the power supply 300 may omit memory entirely. The power supply 300 may accept messages from devices that specify the actual power requirements but not messages identifying a power profile or a battery model. In such embodiments, the device 102, 202 must signal the power requirements directly and not rely on the power supply 300 to determine the power requirements based on merely a power profile identifier or a battery model identifier. In other embodiments, battery database information or identifier database information stored in memory may be automatically updated when an “unknown” device is identified by the power supply 300. Additionally, in other embodiments, manual updating of database information in memory may occur.

In some embodiments, the power supply 300 may be further configured to receive messages containing proprietary information from a respectively coupled device 102, 202. Device 102, 202 may be configured by its manufacturer to send a message that includes information other than those described above, and a power supply made by or for the same manufacturer may be configured to recognize the information. The information may include data that are typically proprietary or specific to devices of the same manufacturer such as battery charging cycles or data for updating or reconfiguring the power supply 300. Thus, manufacturers may provide a power supply 300 that can receive not only, from any device made by any manufacturer and which conforms to the embodiments described above, generic power requirement information, but also receive proprietary information from devices made by the same manufacturer. In other words, a power supply 300 can be configured to include both universal features and proprietary features. In some embodiments, the device 102, 202 may be a legacy device, and the proprietary information may be for legacy devices. Thus, the power supply 300 includes a legacy DC/DC circuit 332 to provide a fixed voltage supply V_{Fixed} for enabling backwards compatibility with legacy devices such as device 102, 202. The DC/DC circuit 332 generates V_{Fixed} by receiving V_{IN} from the AC/DC converter 304 and supplies V_{Fixed} to connected devices such as device 102, 202 over conductor line 326.

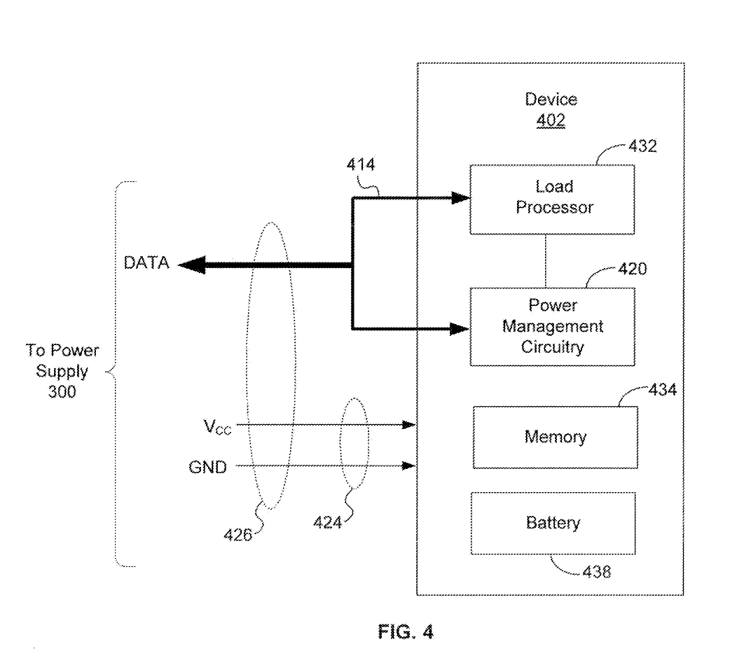

In some embodiments, the power supply 300 and each device 102, 202 may he coupled by a thin cord 342 that includes a conductor line 318 (or power line) and a single communication bus 314. The standard conductor line 318 includes an output voltage supply line from the sense circuitry 312 and ground (or a signal return line). In some embodiments, the communication bus 314 may have multiple functions, including the ability to provide bias power for driving a load processor 432 (shown in FIG. 4) in a respectively coupled device 102, 202. The bias power activates the load processor 432 to determine power requirements of the device 102, 202 from the load processor 432 without having to power the conductor line 318 to first turn the device 102, 202 on. Once the device 102, 202 is turned on and under normal operating conditions, the communication bus 314 is utilized for transmitting power information and other data communications between the power supply 300 and the connected device 102, 202. According to some embodiments, a transceiver 338 and communication bus 314 represent a single-wire bi-directional communication line for establishing communication between the power supply 300 and the device 102, 202 under normal operations, and providing a small bias power to bootstrap the load processor 432 when the device 102, 202 is disabled.

some embodiments, the power supply 300 includes a bias power source 339 coupled to the communication bus 314 capable of generating a current or voltage to activate load processor 432 of the device 102, 202 without having to power up the entire device 102, 202. For example, the bias power source 339 may be a current source. Once the load processor 432 is activated, power information for the device may be communicated to the power supply 300 over the communication bus 314. Thus, the power supply 300 does not have to wait until the device 102, 202 is turned on to determine the power requirements, and the power supply 300 can provide the appropriate level of power to the respectively coupled device 102, 202 without utilizing any excess power for initial power up operations. This versatile bootstrap feature enabled by the bias power source 339 and the communication bus 314 of the power supply 300 addresses the problem of not being able to re-engage a powered-down device and allows for the power supply 300 to be configured for the full required power without having to first turn on the powered-down device. A small bias power only is needed to activate the load processor 432 on the device 102, 202. Once activated, the load processor 432 can exchange power requirements with the power supply 300 before the device 102, 202 is turned on or powered up. Additionally, the communication bus 314 may detect when the device 102, 202 connected or disconnected without additional communication, such as signals to indicate when the device 102, 202 connects or disconnects, between the power supply 300 and the device 102, 202, thus conserving even more power, as will be described in further detail. In other embodiments, the bias current or voltage may be provided by any circuitry in the power supply 300; such circuitry may be additional circuitry to the power supply 300, such as the bias power source 339 or DC/DC circuit 332. In some embodiments, such circuitry may be integrated with existing components such as the DC/DC converter 308 or the sense circuitry 312. In such embodiments, these circuits may include additional wiring to the communication bus 314, or the transceiver 338, so that bias power may be provided to the load processor 432 over the communication bus 314. A mode for providing the bias power from these circuits may be controlled by processor 320 in response to device 102, 202 requirements or power states.

FIG. 4 is a block diagram of device 402 that may be connected to the power supply 300 in accordance with some embodiments. In some embodiments, power line 424 and communication line 414 couples the device 402 of FIG. 4 to the power supply 300 of FIG. 3. In some embodiments, power line 424 and communication line 414 are provided by power cord 426. Device 402 includes a power management circuitry 420, load processor 432, memory 434 and a battery 438. In some embodiments, battery 438 is a rechargeable battery. Communication line 414 is coupled to the power management circuitry 420 and load processor 432 of the device 402. In some embodiments, the load processor 432 is dedicated to communicating with the power supply 300. In other embodiments, the load processor 432 is used to operate device 402 in addition to communicating the power needs of the device 402.

In some embodiments, the communication line 414 provides bias power to the load processor 432 from the power supply 300. The bias power is sufficient to start up the load processor 432 to transmit power requirements to the power supply 300 via the communication line 414. Once the power supply 300 has determined the power requirements of the device 402, the power line 424 is configured to supply power according to the requirements of the device 402.

In some embodiments, the power management circuitry 420 communicates the power needs of device 402. In some embodiments, device 402 communicates its power requirements from the power management circuitry 420 to the power supply 300 via communication line 414 in regular communication intervals, e.g., every 30 seconds. Based on each of these communications, the processor 320 of FIG. 3 configures the power supply 300 to provide the requested amount of power to device 402. In some embodiments, power supply 300 only provides power to device 402 for one communication interval, e.g. 30 seconds, and will not continue to provide power unless the power management circuitry 420 communicates the present power requirements of device 402 before the end of that communication interval.

In some embodiments, the power management circuitry 420 can read the voltage on battery 438 and communicate that information to power supply 300 along with other battery condition information. For example, the power management circuitry 420 can calculate the charge level of battery 438 as a percentage of the capacity of battery 438 or the amount of time until battery 438 is fully charged. Power management circuitry 420 may perform this calculation based on the present voltage and current drawn by battery 438 and the charging profile of battery 438, which may be preprogrammed into the power management circuitry 420. In addition, the power management circuitry 420 and memory 434 can be used to keep track of the number of times battery 438 has been fully charged in order to adapt the charge profile of battery 438 over the life of the battery. The number of times battery 438 has been fully charged may also be used to estimate the remaining life of the battery. Power management circuitry 420 may communicate all of this battery condition information to power supply 300.

As described above, device 402 can be electrically coupled to the power supply 300, and may encompass a variety of electronic devices, including but not limited to consumer electronic devices, cellular phones, multimedia devices, computer devices and peripherals. Some of these devices, such as device 402 may include a battery or batteries 438 and some may not. The battery (or batteries) 404 may be rechargeable or non-rechargeable. Examples of rechargeable battery technologies include lithium-ion batteries, nickel cadmium batteries, and nickel metal hydride batteries. Examples of non-rechargeable battery technologies include alkaline and lithium batteries. In some embodiments, if device 402 does not have a battery 438 or non-rechargeable batteries, the power supplied by the power supply 300 merely powers the device 402 for operation. If the device 402 has a rechargeable battery 438, the power supplied by the power supply 300 powers the device 402 for operation and/or recharges the battery 404. As it is known in the art, different devices and batteries have different power requirements for operation and/or battery charging. Thus, the power supply 300 needs to know the power requirements of the device 402, in order to supply the proper amount of power.

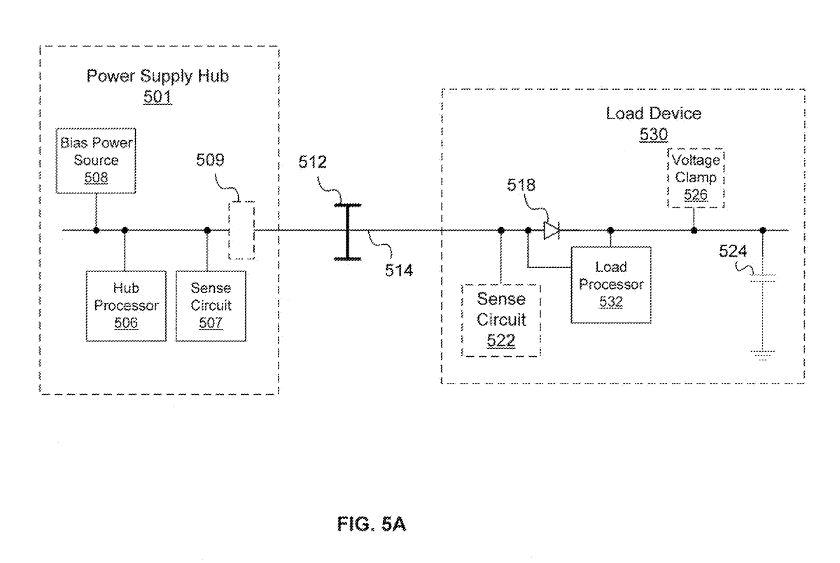

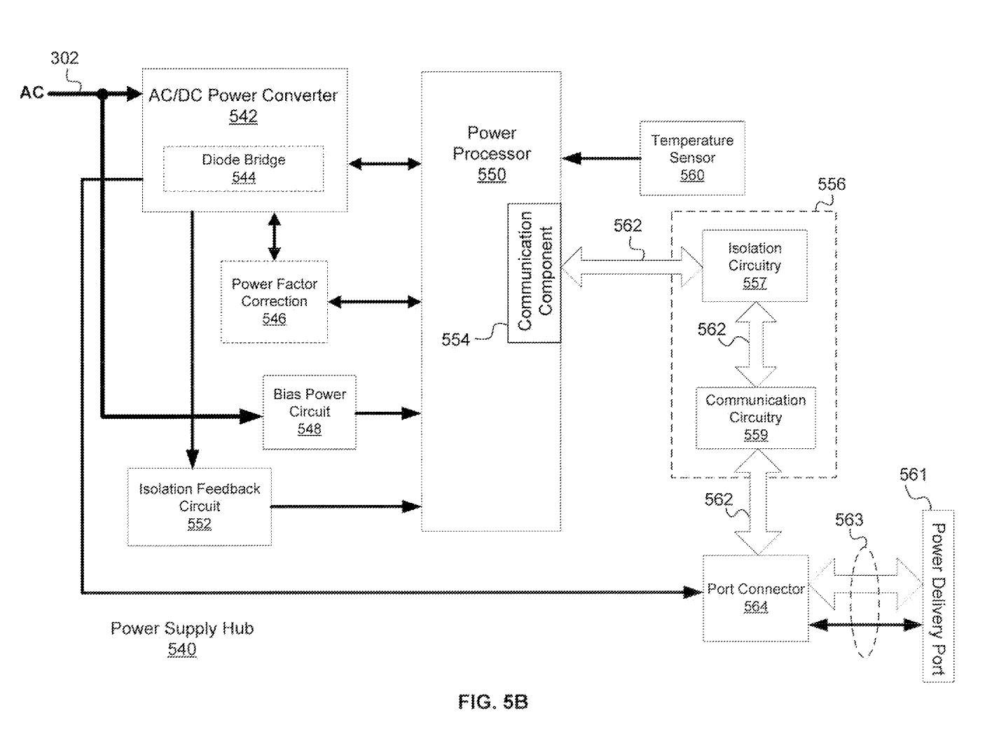

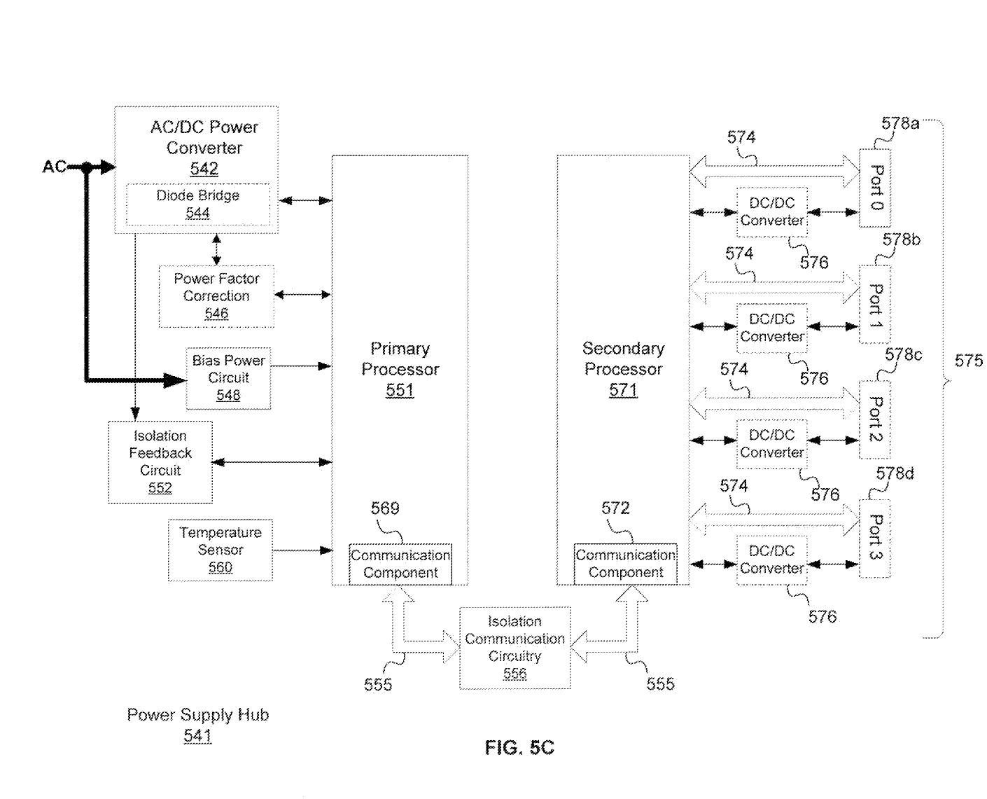

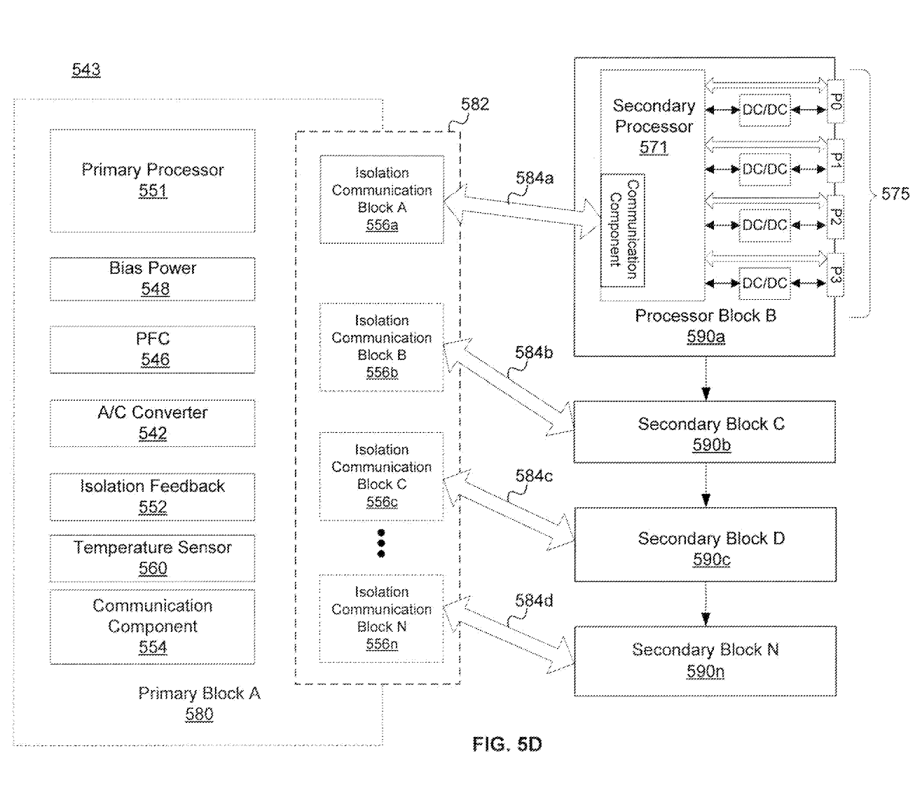

FIG. 5A shows a load device 530, such as device 102, 202, 402, coupled to a power supply hub 501 in accordance with some embodiments. In some embodiments, the power supply hub 501 is a simplified version of the power supply 300 of FIG. 3, and illustrates the operation of a bias power source 508 and processing circuitry, such as a hub processor 506, as they relate to bootstrapping a communication device or processing circuitry such as a load processor 532 in the load device 530. Similar to the communication bus 314, 414, a single communication line 514 having connector 512 connect the power supply hub 501 to the load device 530. The power supply hub 501 includes the bias power source 508 and the hub processor 506 connected to the communication line 514. The bias power source 508 is one illustration of circuitry providing a bias power; thus the bias power source 508 may be any bias power source that, for example, provides a current or generates a voltage supplied over the communication line 514. In some embodiments, a sense circuit 507 is included in the power supply hub 501. Sense circuit 507 detects when the load device 530 is connected to the power supply hub 501.

The load device 530 includes the load processor 532, a diode 518, at least one capacitor 524 and, optionally, a sense circuit 522 and a voltage clamp 526 connecting to the same communication line 514 on the client side.

In some embodiments, upon connection of the power supply hub 501 and the load device 530, the bias power source 508 provides a current to charge the capacitor 524. The charged capacitor 524 is sufficient to activate the load processor 532. Once turned on, the load processor 532 transmits data on the communication line 514 to communicate to the hub processor 506 power requirements for the device 402. The diode 518 assures uni-directional flow of current from the bias power source 508 to the capacitor 524. The voltage clamp 526 regulates the voltage across the capacitor 524 to enable the load processor 532 to function properly. The sense circuit 522 allows the electrical detection of a device, such as power supply hub 501, connected to load device 530.

In some embodiments, the power supply hub 501 includes isolation communication circuitry 509 that establishes isolation boundaries between high and low power regions of the power supply hub 501 circuitry, as will be further described in later sections. In some embodiments, a single isolation boundary is established on communication line 514 that facilitates an isolation boundary between the connector 512 and parts of the hub processor 506. In some embodiments, one or more isolation boundaries may be established within components of the power supply hub 501 circuitry. In one example, an isolation boundary may exist within bias power source 508 (or any other bias power source, not shown), separating the high power and low power boundaries of the bias power source 508. In one example, an isolation boundary may be established between high power and low power boundaries within the sense circuit 507.

FIG. 5B illustrates a block diagram of a power supply hub 540 that represents another embodiment of power supply hub 501 of FIG. 5A, according to another embodiment. Power supply hub 540 includes isolation components 552, 556 that allow isolation between high power and low power regions of power supply hub 540. Power supply hub 540 includes a power processor 550 having a communication component 554 that enables communication to the power processor 550 through power delivery port 561 via isolation communication circuitry 556. The communication component 554 may provide multiple uses in the power supply hub 540. The communication between a load device (such as load device 530, not shown) at power delivery port 561 and the power processor 550 may be enabled by communication component 554 via communication links 562, 563. Thus, the communication component 554 facilitates processor-to-port communication between the power processor 550 and port connector 564. The communication component 554 may also be configured to have customized signaling that are designed to be energy efficient for energy-saving communication across communication links 562, 563. Additionally, communication component 554 may utilize external wiring of communication circuitry 559 to internally communicate across isolation boundaries established between high voltage and low voltage regions of the power processor 550 and/or established by isolation circuitry 557. Communication component 554 may be a PHY layer or any circuitry that includes transmission technologies known in the art.

In some embodiments, the power processor 550 controls high voltage components as well as communicating to or controlling low voltage components to deliver power to a load device (not shown) at power delivery port 561. For ease of reference, the control of high voltage components is the primary domain and the control of the low voltage components is the secondary domain of the power processor 550.

In some embodiments, the power delivery port 561 may be a physical plug-in connector, or any device or mechanism that allows communication to or transmission of data and power to the load device (not shown). For example, the power delivery port 561 may be a wireless link that allows wireless transmissions to the load device (not shown).

The power supply hub 540 additionally includes an AC/DC power converter 542 for converting received AC power into DC power to supply to a load device (not shown). The AC/DC power converter 542 may be configured in any way known in the art. In some embodiments, power is converted from AC to DC through a rectifier, such as Diode Bridge 544. In some embodiments, the power supply hub 540 includes a Power Factor Correction (PFC) circuit 546 as a secondary power supply or for facilitating adjustments to the supplied power. As will be apparent to a person of ordinary skill in the art, the AC/DC converter 542 and/or PFC circuit 546 may be of any other circuitry that interfaces between AC power and the power conversion to DC power.

In some embodiments, the circuitry of low voltage components (e.g., circuitry relying on DC power) is physically isolated from the circuitry of high voltage components (e.g., circuitry relying on AC power) using one or more isolation devices on the power processor 550 to create one or more isolation boundaries. Examples of isolation devices include transformers, optocouplers, proximity detectors, or any circuitry known in the art to isolate a region of high voltage from a region of low voltage.

Isolation communication circuitry 556 creates an isolation boundary between high voltage components (primary domain) and low voltage components (secondary domain) of the power supply hub 540 on the communication path 562. In some embodiments, the isolation communication circuitry 556 includes isolation circuitry 557 and communication circuitry 559. Isolation circuitry 557 may be any isolation device that physically isolates one or more high voltage components from low voltage components of the power supply hub 540, or more specifically, the power processor 550. In some embodiments isolation communication circuitry 556 includes communication circuitry 559 that facilitates communication across one or more isolation boundaries created by the isolation circuitry 557. For example, isolation communication circuitry 556 creates one or more isolation boundaries to separate primary and secondary domains of the power supply hub 540 or the power processor 550, but allows transmissions between the power processor 550 and the load device (not shown) at power delivery port 561 on the communication path 562.

Isolation feedback circuit 552 receives signals from the AC/DC converter 542 to provide feedback to the power processor 550 and to control the DC output to port connector 564 for delivery of power to the load device (not shown) at power delivery port 561.

Similar to the thin cord 342 of FIG. 3, power and data transmissions are delivered to the load at power delivery port 561 via electrical cord 563 that includes a power line and a single communication line.

In some embodiments, the power supply hub 540 additionally includes a bias power circuit 548, which provides an auxiliary power source to the power processor 550 or to other circuitry in the power supply hub 540. Additionally, the bias power circuit 548 may be configured similarly to bias power source 339 of FIG. 3 to provide bias power on the communication link 562 for activating the processing circuit of a load device, for example, when the load device is powered down. The bias power circuit 548 may be supplied a power source (e.g., AC power) via electrical bus 302. In other embodiments, the bias power circuit 548 may generate bias power internally, utilizing internal circuitry as a source of power.

As previously described, the power processor 550 regulates and controls various circuitry in the power supply hub 540, including the AC/DC power converter 542, PFC 546, bias power circuit 548, isolation feedback circuit 552, isolation communication circuitry 556, and so on. Additionally, the power supply hub 540 may include a temperature sensor 560 for detecting the temperature of the power supply hub 540 environment. As will apparent to one of ordinary skill in the art, the power supply hub 540 may include other devices and sensors similar to the temperature sensor 560 to monitor other parameters of the power supply hub 540.

FIG. 5C illustrates a block diagram of a multiport power supply hub 541, representing another embodiment of power supply hub 501 of FIG. 5A, according to some embodiments. FIG. 5C additionally includes a primary processor 551 and a secondary processor 571, each of which has a respective communication component 569, 572. The primary processor 551 is similarly configured as the power processor 550 of FIG. 5B except that the primary processor 551 regulates and controls high voltage components (primary domain) of the power supply hub 541. For example, the primary processor 551 and its peripheral components utilize a high power source (e.g., AC power) to facilitate the conversion of AC power to DC power. Some of the same circuit elements in FIG. 5B are included in FIG. 5C, and share the same reference numbers. In the interest of brevity, the descriptions of these same circuit elements are not repeated.

The secondary processor 571 regulates and controls low voltage components (secondary domain) of the power supply hub 541. For example, the secondary processor 571 facilitates providing DC power to one or more load devices (not shown) that may be connected to one or more ports 578a-d. Each of the ports 578a-d are configured to receive DC power converted by DC/DC converters 576 for each respective port, and power and data transmissions on communication lines 574 to deliver to connected load devices (not shown). These DC power components and connections are collectively peripheral components 575.

The control of the primary domain by the primary processor 551 is physically isolated from the control of the secondary domain by the secondary processor 571 by isolation communication circuitry 556. The communication components 569, 572 communicate with the isolation communication circuitry 556 via communication links 555 to allow transmissions on the communication links 574 to be communicated to the primary processor 551. The isolation communication circuitry may consist of one or more isolation devices for establishing isolation boundaries between the primary and secondary domains controlled by primary and secondary processors 551, 571 respectively.

In some embodiments, the communication components 569, 572 may be configured similarly to communication component 554 of FIG. 5B, except that two communication components 569, 572 are included due the isolation between primary processor 551 and secondary processor 571. The communication component 569 is housed in primary processor 551 and communication component 572 is housed in secondary processor 571. Similar to communication component 554 of FIG. 5B, communication components 569, 572 provide multiple uses in the power supply hub 541. The communication component 572 facilitates processor-to-port communications between one or more load devices (such as load device 530, not shown) and the secondary processor 571. In some embodiments, the communication component 572 services communication links 574 to multiple ports for connecting to multiple load devices. Both communication components 569, 572 also communication with respect to each other via communication link 555 and may utilize external wiring of isolation communication circuitry 556 to allow communication across the isolation boundaries established between the primary and secondary processors 551, 571. Additionally, communication components 569, 572 may also be configured to have customized signaling designed to be energy efficient for energy-saving communication across communication links 555, 574. Communication components 569, 572 may be PHY layers or any circuitry that includes transmission technologies known in the art. It will be appreciated that various uses of the communication components 554, 569, 572 in processors 550, 551, 571 described are provided as examples. An ordinary person skilled in the art may utilize any other configuration using communication components 554, 569, 572 to achieve communication across isolation boundaries, communication to one or more load devices, to maximize energy efficiency of communication links, or the like in power supply hubs 540, 541.

FIG. 5D illustrates another block diagram of a multiport power supply hub 543 having multiple secondary processors 571 according to some embodiments. Power supply hub 543 illustrates another embodiment of power supply hub 501 of FIG. 5A. Some of the same circuit elements in FIGS. 5B and 5C are included in FIG. 5D, and share the same reference numbers. In the interest of brevity, the descriptions of these same circuit elements are not repeated. Primary block A 580 illustrates components controlled by primary processor 551, and includes high voltage components described as the primary domain region of the power supply hub 543. Primary block A additionally includes a plurality of isolation communication blocks 556a-556n, each configured similarly to isolation communication circuitry 556 to communicate with a plurality secondary processor blocks A-N 590a-590n. The plurality of secondary processor blocks A-N 590a-590n allows multiple secondary processors 571 to be serviced by a single primary processor 551 across isolation boundaries created by isolation communication blocks 556a-556n. In some embodiments, the isolation communication blocks 556 may be configured as a single isolation communication system 582 configured to establish isolation boundaries and communicate with multiple secondary blocks 590a-n having secondary processors 571. Each secondary block 590 is configured similarly to the second processor block 571 and peripheral components 575 of FIG. 5C.

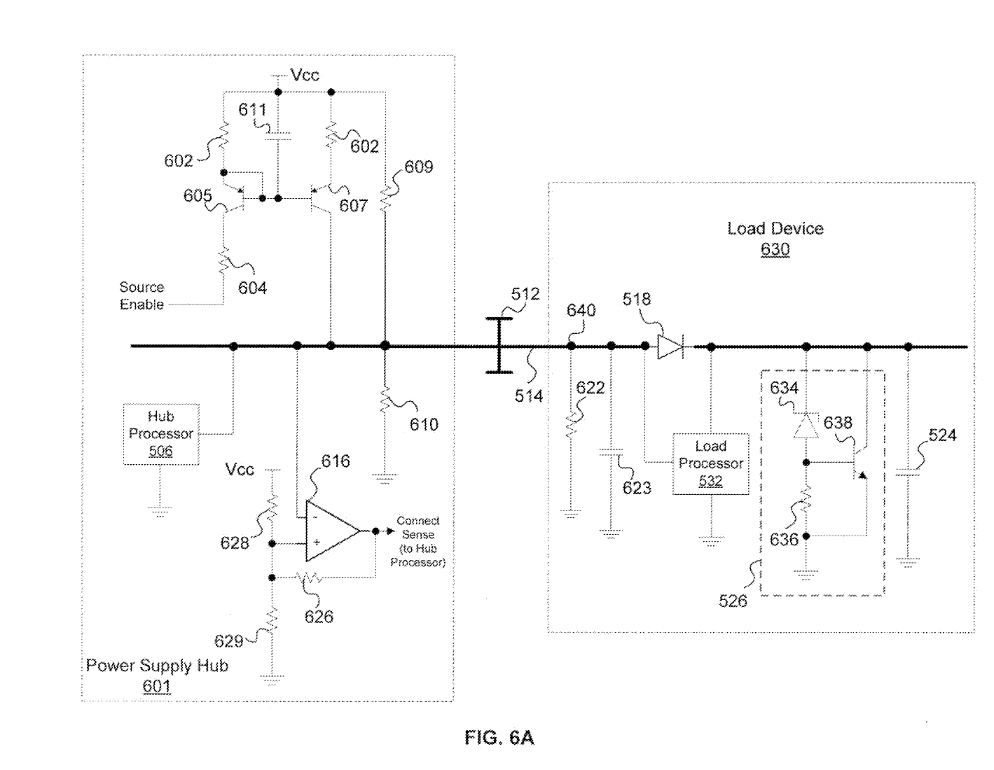

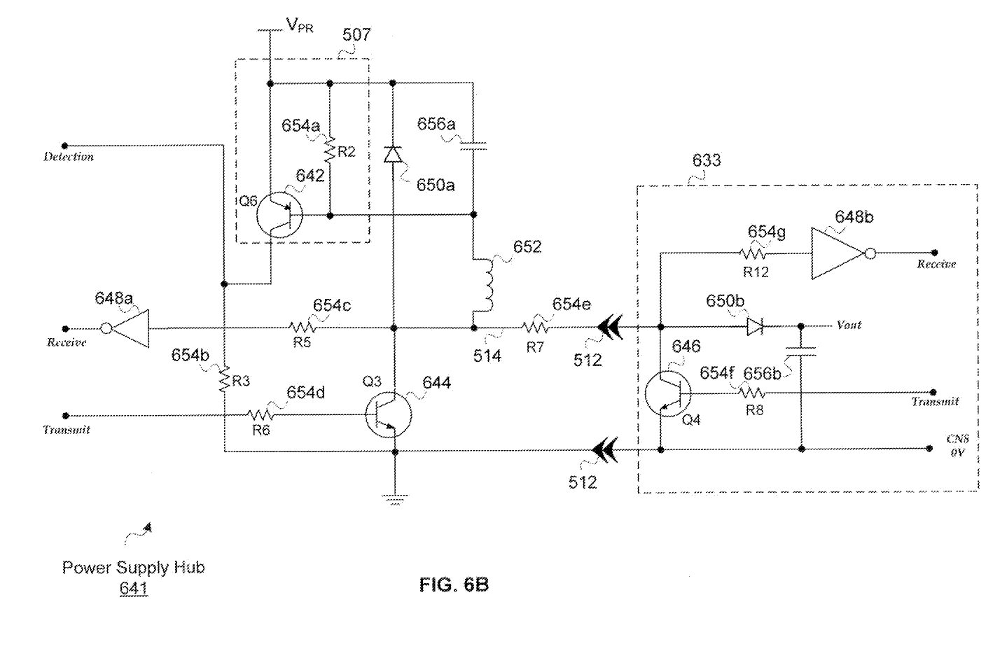

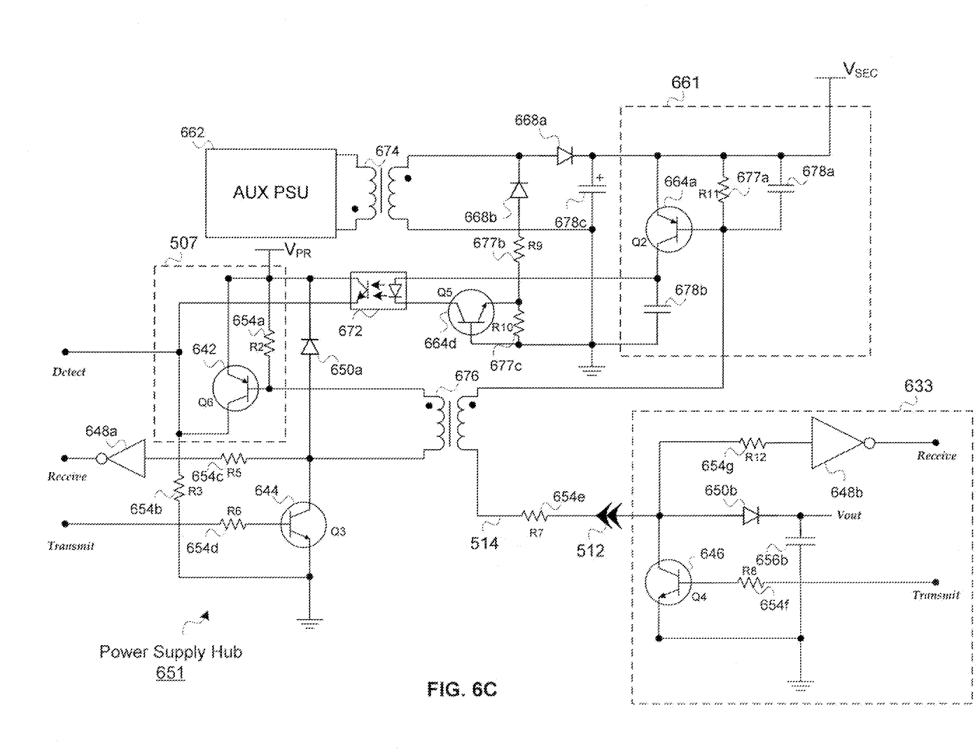

FIG. 6A is an embodiment of the circuitry of the load device 530 coupled to power supply hub 501 of FIG. 5A according to some embodiments. The detailed circuitry of a power supply hub 601 and load device 630 are shown. In some embodiments, the bias power source 508 includes transistors 605, 607 coupled together in a current mirror configuration. The emitters of the transistors 605, 607 are coupled to resistors 602, which are also coupled to supply voltage Vcc. A capacitor 611 is also included in the current mirror configuration between the bases of transistor 605, 607 and the supply voltage Vcc. The collector of the transistor 605 is additionally configured to receive a control signal Source Enable from the hub processor 506 driven by a resistor 604. In some embodiments, the current mirror configuration includes resistors 609, 610 to form a voltage divider coupling the communication line 514, and is used to match impedance required for powering certain load devices connected via the communication line 514. Additionally, resistor 622 in conjunction with resistors 609 and 610 function as a voltage divider to allow the electrical detection of a connected load device.

In some embodiments, the power supply hub 601 further includes control circuitry that includes a comparator 616 with a first input node coupled to the communication line 514 and a second input coupled to receive a reference voltage input coupled between supply voltage Vcc and ground. The reference voltage input is regulated by coupling to the output of the comparator 616 via resistor 626 in a feedback configuration and resistors 628, 629. The output of the comparator circuit 616 is coupled to the hub processor 506 to provide a control signal Connect Sense that allows the power supply hub 601 to detect whether a load device, such as device 102, 202, 402, is connected or disconnected to the power supply.

In some embodiments, the voltage clamp 526 in the load device 630 includes a zener diode 634 having an input coupled to a resistor 636 and the base of a transistor 638. The output of the zener diode 634 is coupled to the output of the diode 518. The resistor 636 is additionally coupled to ground. The collector of the transistor 638 is coupled to the output of the diode 518 and the emitter is coupled to ground. The voltage clamp 526 regulates current levels from the diode 518 that charges the capacitor 524 to control the voltage across the capacitor 524.

FIG. 6B illustrates the circuitry of the load device 633 coupled to power supply hub 641, according to some embodiments. Power supply hub 641 is another embodiment of power supply hub 501 of FIG. 5A, and load device 633 is another embodiment of load device 530 of FIG. 5A and 630 of FIG. 6A. It will be appreciated that all or a subset of the circuitry in the power supply hub 641 may be included in hub processor 506 of FIG. 5A, power processor 550 of FIG. 5B, and secondary processor 571 of FIG. 5C. As in FIG. 5A, data is transmitted or received by the processor 506, 550 (not shown) on the communication line 514. The processor 506, 550 communicates to load device 633 coupled to connector 512 via communication line 514.

When data is transmitted to the load receiver, a transmit signal is applied to the base of a transistor Q3 644 coupled between a voltage potential V_{PR} and ground. The transmit signal is applied to the base of transistor Q3 644 through resistor 654d. In response, the transistor 644 is turned on causing current flow through the transistor 644 due to the emitter being connected to ground. Thus, a connection to the load 633 receiver is established and the data signal is driven through resistor 654e to the receiver port on the load side through resistor 654g and buffered out through buffer 648b.

Similarly, when the load transmits a signal to the processor 506 on the communication line 514, a transmit signal is applied to the base of a transistor Q4 646 through resistor 654f on the load device 633. In response, the transistor 646 is turned on, causing current to flow through the transistor 646 and driving a signal through resistor 654e on the communication line 514 to the receiver node of the processor 506, 550 (not shown). Like the receiver port of the load device 633, the receiver port of the processor 506, 550 (not shown) receives the data transmission pulled by resistor 654c and buffered out through buffer 648a.

It will be apparent to an ordinary person skilled in the art that other circuit components such as diodes 650a, 650b and capacitors 656a, 656b respectively coupled to the collector nodes of the transistors 644, 646 provide uni-directional flow of current or the proper setting of voltage levels for correction operation of circuit components.

Power supply hub 641 additionally includes a sense circuit similar to sense circuit 507 of FIG. 5A according to other embodiments. The sense circuit 507 of FIG. 6B includes a transistor 642 having its emitter coupled to the primary voltage potential V_{PR}, its collector coupled to a detection port, and its base coupled to a load output node Vₒᵤₜ on the load side.

When load device 633 is not connected to the power supply hub 641, the base of the transistor 642 is at the voltage potential V_{PR} pulled up by resistor 654a. Since the base and emitter of transistor 642 are at the same voltage, transistor 642 is turned off and the detection port is pulled to ground by resistor 654b indicating there is no device connected to the power supply hub 641.

When load device 633 is connected at connector 512, communication line 514 is enabled and the base of transistor 642 is connected to Vₒᵤₜ. The voltage at Vₒᵤₜ is such that the base of the transistor 642 is pulled low relative to the emitter, and causing the transistor 642 to turn on. The detection port at the collector of transistor 642 is pulled up towards voltage potential V_{PR} to sense that the load device 633 is connected.

The power supply hub 641 circuitry of FIG. 6B additionally includes another embodiment for supplying bias power to the load device 633 utilizing a magnetic device, such as an inductor 652. The magnetic device may be any other energy storage device or circuitry that may be utilized as a source of backup or storage power. On one end, the inductor 652 is coupled receive the voltage potential V_{PR}. On the same end, the inductor 652 is additionally coupled in series to a capacitor 656a on the V_{PR} side. The capacitor 656a and inductor 652 are additionally coupled in parallel to a diode 650a. On the other end, the inductor 652 is coupled ground via transistor 644 and transistor 646 when the load device 633 is connected.

Whenever current is pulled through either transistor 644, 646, current is also flowing through inductor 652. Thus, energy is stored across the inductor 652. The capacitor 656a provides a filtered voltage level for energy to flow through the inductor 652, thus allowing energy to be stored. The diode 650a assures uni-directional flow of current from the transistors 644, 646. When transistors 644, 646 are turned off, the stored energy may be supplied to the load device 633 via communication line 514 as usable bias power. As previously described, the bias power stored in the inductor 652 may be provided via communication line 514 to activate a processor (not shown) on the load device 633 when the load device 633 is, for example, in sleep mode or is powered down. Thus energy is scavenged for power conservation and the single communication line 514 may be utilized for multiple purposes of data transmission and bias power generation.

FIG. 6C is a schematic of the circuitry of a power supply hub 651 and load device 633 according to some other embodiments. The power supply hub 651 of FIG. 6C is another embodiment of the power supply hub 501 of FIG. 5A. Some of the same circuit elements in FIGS. 5A and 6B are included in FIG. 6C, and share the same reference numbers. In the interest of brevity, the descriptions of these same circuit elements are not repeated. It will be appreciated that all or a subset of the circuitry in the power supply hub 651 may be included in hub processor 506 of FIG. 5A, power processor 550 of FIG. 5B, and processors 551, 571 of FIG. 5C. The power supply hub 651 of FIG. 6C additionally includes isolation circuitry 672, 674, 676 for isolating the high voltage configurations of the primary domain from the low voltage configurations of the secondary domain in power supply hub 651. In some embodiments, specific pathways in the power supply hub 651 may be isolated by different isolation components 672, 674, 676. It will be appreciated that all the isolation circuitry 672, 674, 676 or a combination of circuit components may be utilized to achieve the desired isolation boundaries of the power supply hub 651. Additionally, an ordinary person skilled in the art may utilize any other circuit component or combination of components to achieve the effect of isolation boundaries in power supply hub 651.

In some embodiments, power supply hub 651 of FIG. 6C additionally includes an auxiliary power supply unit (“Aux PSU”) 662 of the primary domain providing power to a driver circuit 661 of the secondary domain through an isolation component transformer 674. The driver circuit 661 is further isolated from the sense circuit 507 by optocoupler device 672. A third isolation component, transformer 676, further isolates the processor (not shown) from the load connector 512 on the communication line 514. It will be appreciated that sense circuit 507 and the circuitry for transmitting data signals over the communication line 514 are supplied primary voltage potential V_{PR}, and the driver circuit 661 for providing bias power on the communication line 514 to the load device 633 is supplied a secondary voltage potential V_{SEC} (e.g., low DC power source). V_{PR} is the main voltage supply for the primary domain and V_{SEC} is the main voltage supply for the secondary domain, although components of primary and secondary domains may be supplied power from either V_{PR} or V_{SEC}.

The driver circuit 661 includes transistor Q2 664a having an emitter coupled to the voltage potential V_{SEC}, a base coupled to V_{SEC} via resistor 677a, and a collector coupled in series to capacitor 678b. Resistor 677a is additionally coupled in parallel to capacitor 678a.

When load device 633 is not connected, the emitter and base (pulled up to V_{SEC} by resistor 677a) of the transistor 664a have the same voltage, thus the transistor 664a is turned off. Upon connection by load device 633, the voltage at Vₒᵤₜ of the load 633 is such that the base of the transistor 642 is pulled low relative to the emitter to turn the transistor 664a on.

However, the conduction path of transistor 664a is in series with the conduction path of the optocoupler 672 via transistor 664d. Thus, in order for the sense circuit 507 to detect the connection of the load device 633, a conduction path between the driver circuit 661 and the sense connect circuit 507 must be enabled.

The operation of the optocoupler 672 as an isolation component and the transistor 664d is now discussed relative to transistor 664a. With the transistor 664a turned on and conducting current, the optocoupler 672 is enabled to permit conduction while maintaining the isolation boundary between the sense circuit 507 of the primary domain and the transistor 664d, which rests with the secondary domain along with driver circuit 661.

In order for the optocoupler 672 to conduct, the transistor 664d must be turned on. Similar to the transistor 664a, the base of the transistor 664d must be lower than its emitter to turn on the transistor 664d. The Aux PSU 662 provides an AC source having a duty cycle that includes a very narrow negative pulse width between pulsed durations of high and low voltage levels of a rectangular waveform. When transistor 664a is turned on and a duty cycle of the negative voltage is being asserted, transistor 664d is briefly turned on. At that time, both transistors 664a, 664d are turned on for a brief time period to conduct current through the optocoupler 672.

The combination of the Aux PSU 662 and transistor 664d provide an additional advantage. Since optocouplers, such as the optocoupler 672, need a high current source to function linearly (ideal operating conditions) the narrow negative pulse-width of the Aux PSU 662 alternating current source pulses the optocoupler 672 with short periods of high current when need. In other words, high current is conducting through the optocoupler 672 when the load device 633 is connected. Thus, a constant high current source is not needed to operate the optocoupler 672 at ideal operating conditions even if the optocoupler 672 has degraded, while the overall power loss minimized.

In addition to the isolation configurations described above, transformer 676 provides a general isolation boundary on the communication line 514 between the load device 633 and the processor (not shown) of the power supply hub 651.

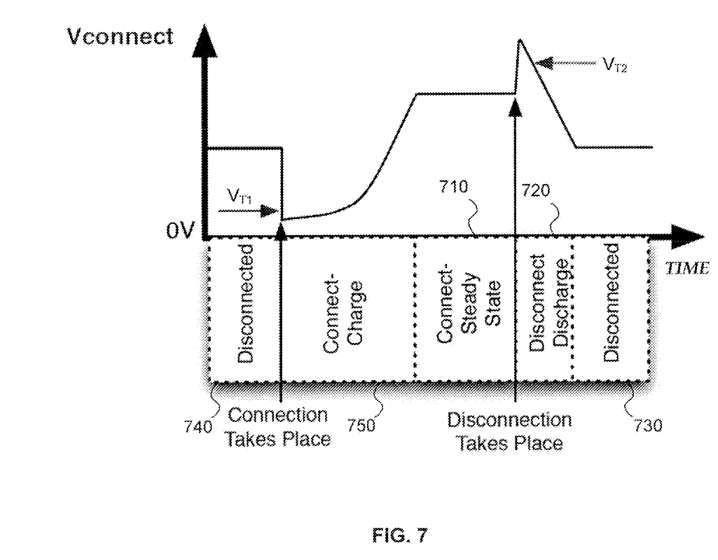

FIG. 7 is a signal diagram showing the operation of the block diagram and circuit of FIGS. 5A and 6A in accordance with some embodiments. In operation, when the load device 530, 630 is connected to the power supply hub 501, 601 by the communication line 514 in a connected steady state 710, all the circuitry is active. In some embodiments, the voltage at node 640 is established by the combination of a current from the bias power source 508 provided to the capacitor 524 whose voltage is regulated by the voltage clamp 526. The current is provided to the capacitor 524 via the communication line 514 to which the bias power source 508 is coupled. In some embodiments, during the connected steady state 710, the amount of current provided by the bias power source 508 is ample to sustain a proper voltage across the capacitor 524 by the voltage clamp 526, thus enabling the load processor 532 to function properly.

Upon physical disconnection of the load device 530, 630 from the power supply hub 501, 601 at a disconnected discharge state 720, the bias power source 508 continues to remain active to provide current and the current through resistors 609, 610 increases the steady state voltage to a higher level due to the voltage drop across the resistor 610 when the communication line 514 is physically disconnected. The rapid ascent of voltage reaches a threshold voltage V_{T2}, which signals the comparator circuit 616 and allows the power supply hub 501, 601 to detect that a disconnection event is occurring. In response to V_{T2} the comparator circuit 616 outputs an active LOW Connect Sense signal to transmit to the hub processor 506. The hub processor 506, in response, generates a high impedance Source Enable signal to disable the bias power source 508. When the bias power source 508 is turned off, the voltage across the resistor 610 continues to drain until a steady OFF state is reached at a disconnected state 730. With the current source 508 disabled, the steady OFF state is a voltage determined by Vcc and resistors 609, 610.

Upon a connection of the load device 530, 630 to the power supply hub 501, 601 by the connector 512 at the end of a disconnected state 740, the discharged voltage across capacitor 524 and capacitor 623 appear across the communication line 514, thereby establishing a Vconnect voltage at node 640 towards ground. This rapid descent of the voltage at node 640 crosses a second threshold voltage, V_{T}, which signals the comparator circuit 616 that a connection event is occurring. In response to V_{T1}, the comparator circuit 616 outputs an active HIGH Connect Sense signal to the hub processor 506. The hub processor 506 turns on the bias power source 508 by sending an active LOW Source Enable signal in response to receiving the HIGH Connect Sense signal. The current from the bias power source 508 begins to charge up the voltage across the capacitor 524 via the communication line 514 during a connect-charge state 750 until the voltage Vconnect reaches the connected steady state that is additionally regulated by the voltage clamp 526.

Once the connect-steady state 710 is established, the charged capacitor 524 has sufficient bias power to activate the load processor 532, thus enabling the load processor 532. Once the load processor 532 is in operation, any data for determining the power requirements of the load device 530, 630 can be transmitted to the power supply hub 501, 601 via the communication line 514. In some embodiments, the communication line 514 may have multiple functions in addition to data communication between the hub processor 506 of the power supply hub 501, 601 and the load processor 532 of the load device 530, 630. The communication line 514 may be utilized to provide bias power to the load processor 532. The communication line 514 may also be utilized to sense when a particular load device 530, 630 is connected or disconnected to the power supply hub 501, 601. When a connection has occurred electrically and the connection is detected on the communication line 514, the communication can take place between the hub processor 506 and the load processor 532. Conversely, when a disconnection has occurred and the disconnection is detected on the communication line 514, the source of power can be appropriately turned off. Thus, power savings and standby power are enhanced, and less power is unnecessarily wasted.

In some embodiments, an additional feature of powering the load processor 532 by supplying current over the communication line 514 is that a very low power may be maintained without terminating the communication between the power supply hub 501, 601 and the load device 530, 630. Since the current from the bias power source 508 is used to charge the capacitor 524 over the communication line 514, the load processor 532 is powered by the charged capacitor 524 on the load device 530, 630. In some embodiments, the current from the bias power source 508 may be turned on and off to a duty cycle that is sufficient to keep the capacitor 524 charged continuously, and hence power the load processor 532 irrespective of the power state of the larger load device 530, 630. In some embodiments, the current mirror of the bias power source 508 is switched on and off on a minimal duty cycle to keep the load processor 532 activated. In some embodiments, the DC/DC converter 308 of FIG. 3 is switched on and off in a minimal duty cycle to keep the load device 630 turned on, based on information provided by the load processor 532 via the communication line 514 during a low power state of the load 530, 630. In some embodiments, the AC/DC converter 304 may be switched on and off to a minimal duty cycle to control the bias power to the load processor 532 over the communication line 514. These capabilities allow for the minimal amount of power to be supplied by the power supply hub 501, 601 and the optimal use of power by the load devices 530, 630. These capabilities further allow the power supply hub 501, 601 to provide a wide range of power levels at various states of the load device 530, 630 (e.g., powered down, low standby mode, power saving mode, powered up mode, transitions between power states, and so on).

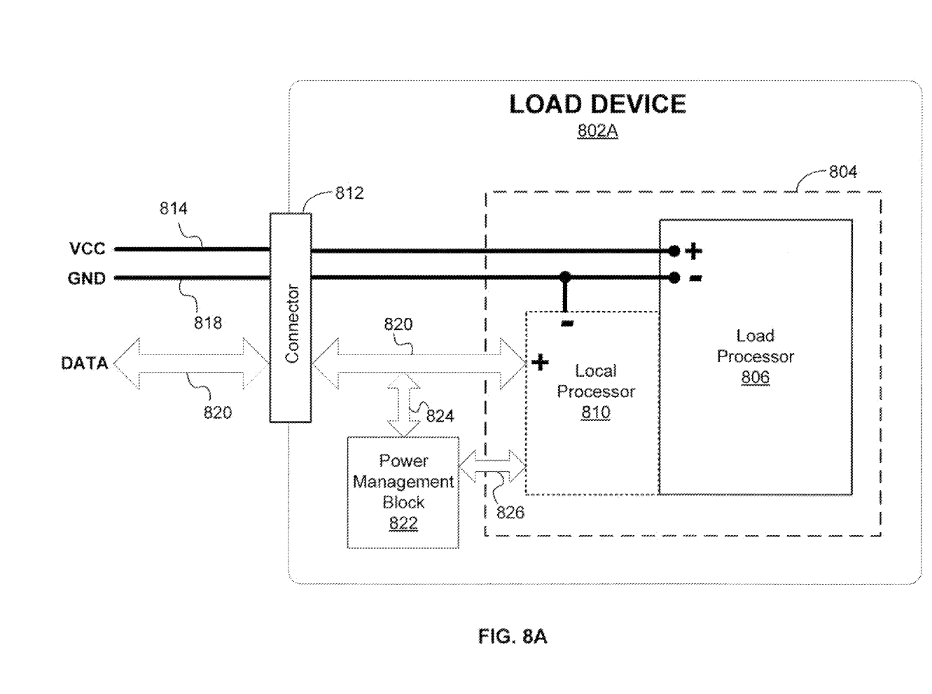

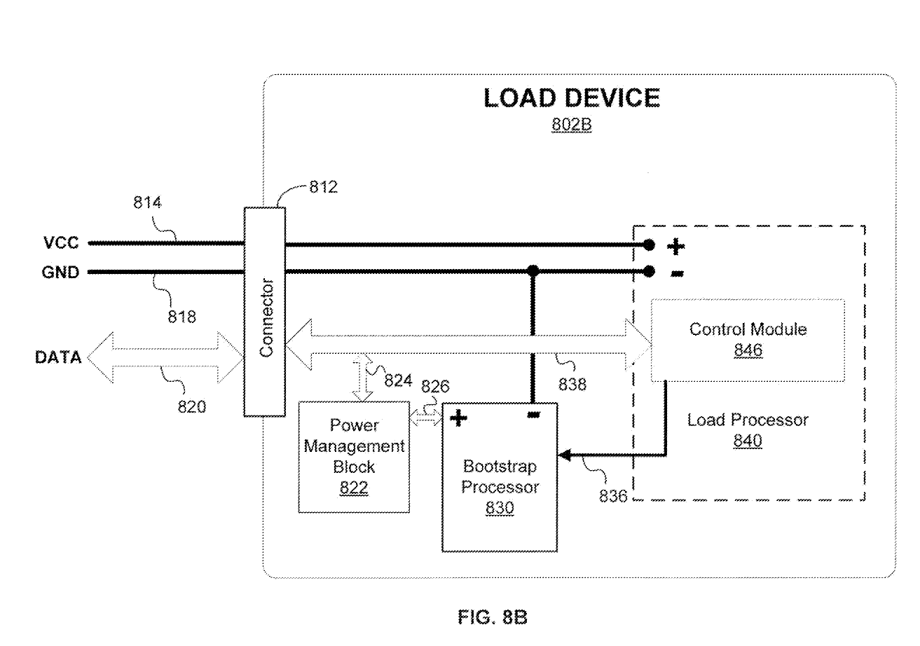

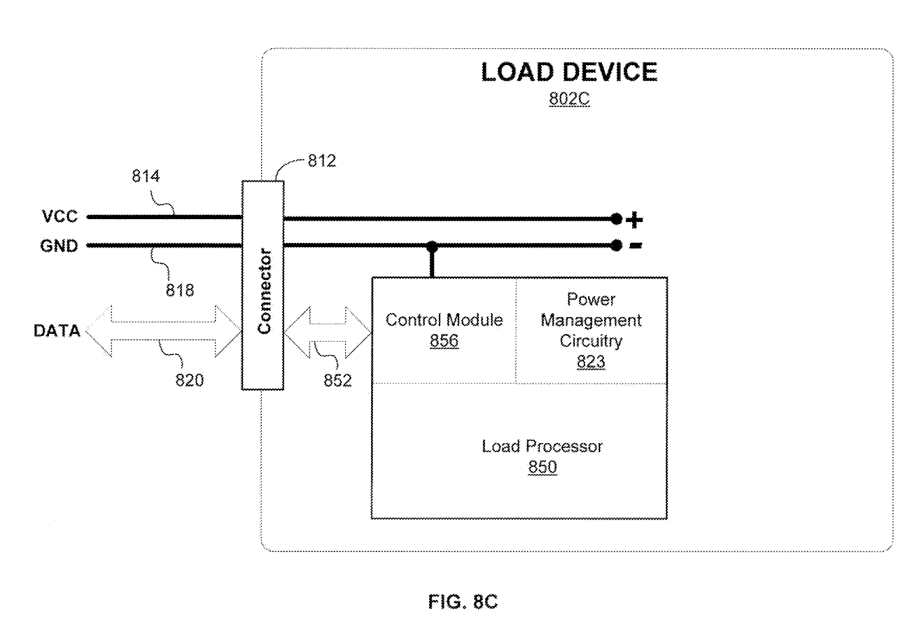

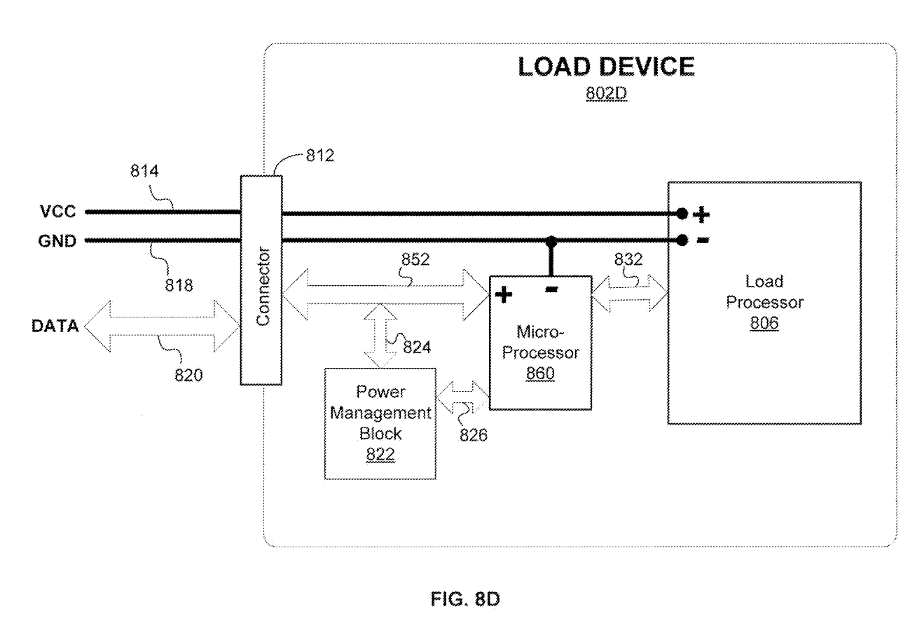

FIGS. 8A-D are block diagrams illustrating several types of load devices 802A-D that may be devices 102, 202 or 402 of FIGS. 1, 2 and 4 in accordance with some embodiments. In some embodiments, the load device 802A includes a load processor 806 in a load module 804 of the load device 802A. In some embodiments, the load processor 806 is configured to receive power from a power supply, such as power supply 300 of FIG. 3, to which the load device 802A is connected via power lines 814, 818 and a communication line 820. The power lines 814, 818 and the communication line 820 are connected to the load device 802A by a connector 812. In some embodiments, a power management block 822 is coupled to the communication line 820, which includes the circuitry described in load device 530, 630, 633 of FIGS. 5A and 6A-C. In some embodiments, the communication line 820 extends directly to the load processor 806, and the communication line 820 is utilized by the power supply 300 and the power management block 822 to receive current from the power supply 300 to generate bias power for activating the load processor 806 before the load device 802A is powered on. Once the load processor 806 is fully functional, data may be transmitted to and from the power supply 300, including power requirements of the load device 802A. Before the load device 802A is turned on, the power supply 300 is able to supply the appropriate level of power to the load device 802A via the power lines 814, 818.

In some embodiments, the load module 804 may include a lower-level local processor 810 configured to be activated by the bias power from the power supply 300 and the power management block 822 over the communication line 820. The power management block 822 may be coupled to receive bias current over the communication line 820 and link 824. The bias current is used by the power management block 822 to generate bias power and supply the bias power to the local processor via link 826. The local processor 810 may be configured such that it requires less power than the load processor 806 to be fully operational, thereby reducing the amount of bias power necessary to enable the local processor 810. Once the adequate power is established for the device 102, 202, 402, the power lines 814, 818, or alternatively the local processor 810, may provide the power necessary for the load processor 806 to operate. In other embodiments, the local processor 810 may be embedded as part of the load processor 806, and only that portion of the load processor 806 may be activated by the bias power generated by the power management block 822 for initiating power up of load device 802A.

FIG. 8B shows a load device 802B according to another embodiment. Some of the elements in FIG. 8A are similarly included in FIGS. 8B-8D and share the same reference numbers. In the interest of brevity, the description for these same elements will not be repeated. The load device 802B additionally includes a bootstrap processor 830 separate from a load processor 840, the load processor 840 including a control module 846. The bootstrap processor 830 represents a smaller device, such as a microprocessor, which allows for biasing the smaller device with minimal power. For example, the bootstrap processor 830 is useful if the load processor 840 requires more power than the bias power supplied or if the system design goal is to use the lowest power level for the bias power. Thus, in some embodiments, the bootstrap processor 830 is a smaller processor capable of establishing a digital communication with the power supply 300, but requiring much less power to operate than the load processor 840. The bootstrap processor 830 may be activated by bias power from the power management block 822, which is generated by a bias current received over the single communication line 820 and while the load device 802B is turned off or in a sleep/power-saving mode. When the bootstrap processor 830 is activated and minimal communication with the power supply 300 is enabled via communication 824, the bootstrap processor 830 sends the power requirements for the load device 8028 to the power supply 300. Once the power supply 300 receives the power requirements, full power is supplied the load processor 840 via power lines 814, 818. Once the load device 802B and the load processor 840 are powered, the control module 846 in the load processor 840 takes control and sends a control signal 836 that disables the bootstrap processor 830, and thereafter taking over all of the power communication with the power supply 300 via communication 838.

In some embodiments, the bootstrap processor 830 is powered over the communication line 820 in a manner such that very low power is achieved without terminating the communication over the communication line 820. This allows for, as previously described, minimal power usage to maintain the communication over the communication line 820 and adjust the power level at various power states of the load device 802B (e.g., transition load device 802B to and from sleep mode, standby mode, off mode, and so on).

In some embodiments, when the load device 802B desires to enter a low power mode, the load processor 840 sends a low power mode request to the power supply 300. In response, the power supply 300 removes power from the load device 802B allowing the full power saving state, while maintaining the bootstrap processor 830 in a minimum power state and providing the minimum power over the communication line 820, 824, 826, 838. When the power state of the load device 802B changes, the bootstrap processor 830 is able to engage in minimal communication with the power supply 300 to request deliver of full power to the load device 802B once again. In some embodiments, the load processor 840 resumes the power communication responsibilities once again, and disables the bootstrap processor 830 by sending the control signal 836 to prevent communication conflict.

In some embodiments, the load device 802B does not include the load processor 840. Instead, the load device 802B is configured such that it does not achieve anything beyond the minimal communication between the bootstrap processor 830 and the power supply 300 over communication lines 820, 824, 826, 838. It will be appreciated that communication lines 824, 826, 838 are not different communication lines, but instead are extensions of the same single-wire communication line 820. In some embodiments, once the load device 802B is powered by power lines 814, 818, the control module 846 sends control signal 836 to disable the bootstrap processor 830 and takes control over communications to the power supply 300. In some embodiments, the control module 846, sends control signal 836 as a power down signal to initiate power-down and disconnection of the load device 802B in a power-saving manner as described previously for FIGS. 5A-D, FIGS. 6A-C, and FIG. 7.

Thus, the bootstrap processor 830 allows the load device 802B to enter and exit a low power mode (or sleep) state when the load processor 840 requires too much power to maintain functionality in this state. The use of low power processors, such as the bootstrap processor 830, allows for the load device 802B to operate at lower power, giving the load device 802B sufficient capabilities to support a wider range of power operations. In other embodiments, the bootstrap processor 830 replaces the higher-powered load processor 840 to improve the power-saving features of the load device 802B. The bootstrap processor 830 requires only a small bias power that is generated by the power management circuit 822 over the single communication line 820 to be fully operational and request appropriate power levels for the load device 802B before the load device 802B is powered on.

FIG. 8C shows a load device 802C according to another embodiment. In some embodiments, a load processor 850 in the load device 802C includes an embedded power management circuitry 823 having the features of the circuitry in load device 530, 630, 633 of FIGS. 5A-D and 6A-C. The load processor 850 and the power management circuitry 823 are controlled by control module 856. In some embodiments, the load processor 850 may be powered by the power management circuitry 823 that receives bias current from the communication line 820 via communication 852, and eliminates the need for a separate low power processor such as bootstrap processor 830. In some embodiments, the control module 856 switches the load processor 850 between a low power mode and full power mode depending on the power needs of the device 102, 202, 402 and different power states. In some embodiments, the load processor 850 is low power enough that it may be powered exclusively by the power management circuitry 823 over the communication line 820, 852. The power lines 814, 818 may provide power to the remainder of the load device 802C once full power is delivered by the power supply 300.

FIG. 8D shows a load device 802D according to another embodiment. The load device 802D includes the load processor 806, a microprocessor 860 that is separate from the load processor 806 and the power management block 822. In some embodiments, the load device 802D is configured similarly to the load device 802B, except that communication 852 over the communication line 820 by the load processor 806 is achieved through communication 832 with the microprocessor 860. Thus, the microprocessor 860 is powered by the power management block 822 over the communication line 820 and the load processor 806 is powered by the power line 814, 818 when full power is delivered to the load device 802D. When the load processor 806 transmits data to the power supply 300, the transmission is first sent to the microprocessor 860 via communication 832, which is in turn sent to the communication line 820, 852. Power communication with the power supply 300 is conducted by the microprocessor 860 via communication line 820, 852. Thus, the microprocessor 860 is powered over communication line 820, 852. It will be appreciated that communication line 824, 826, 852 are extensions of the same single-wire communication line 820. In some embodiments, the microprocessor 860 is powered over the communication line 820, 852 while the load processor 806 is simultaneously powered by the power line 814, 818.

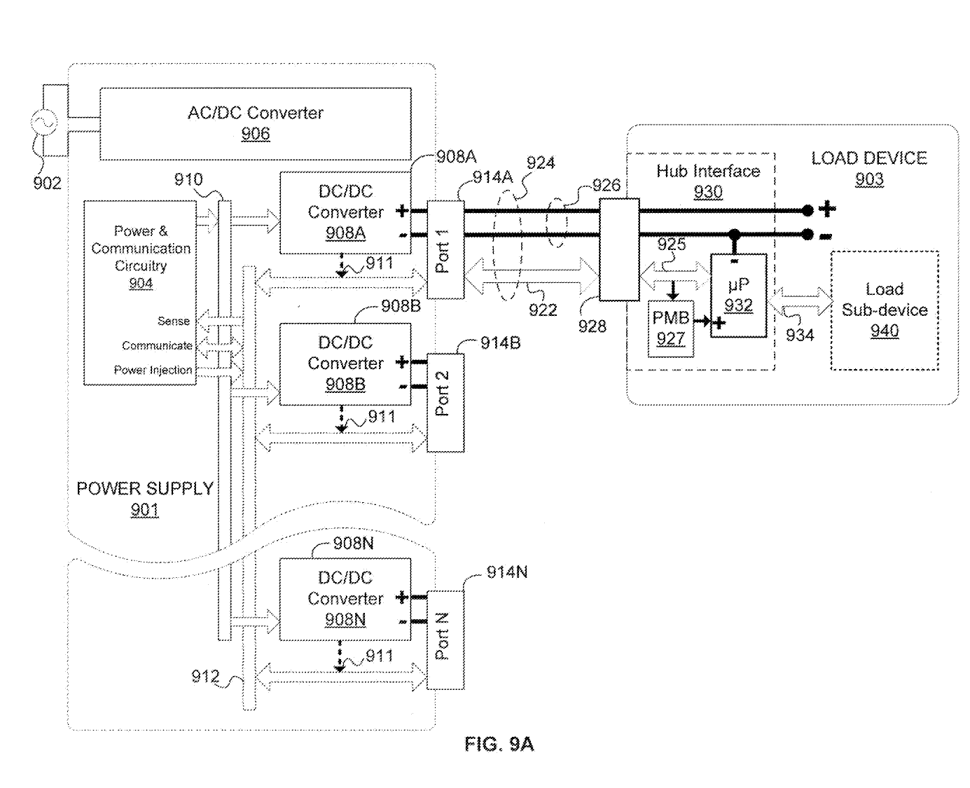

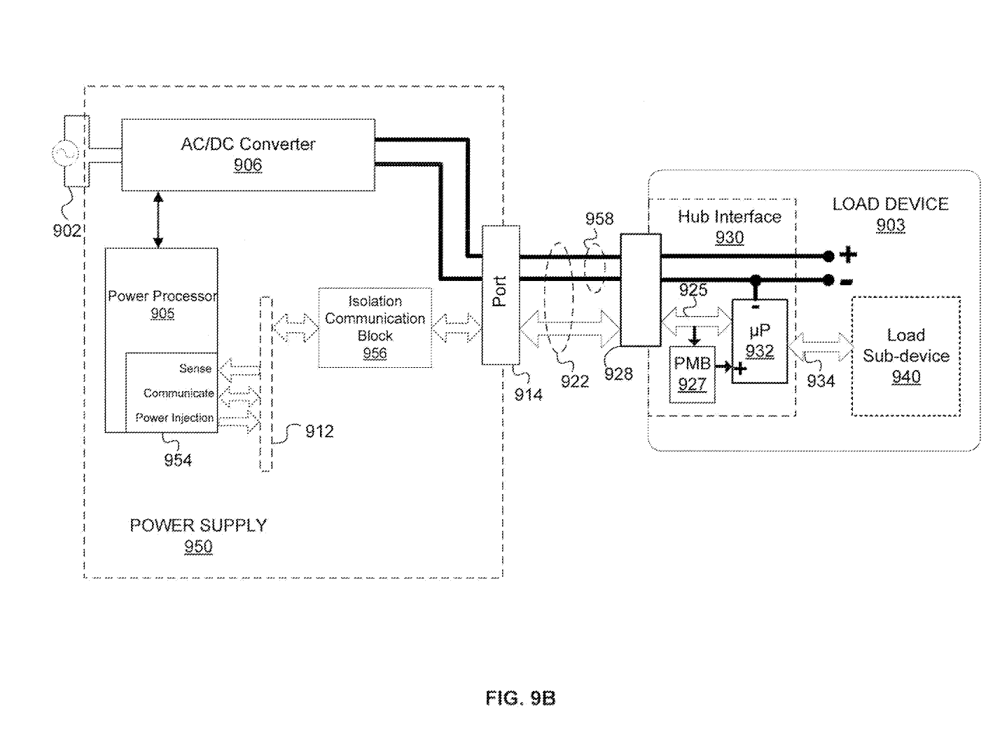

FIG. 9A is a block diagram illustrating a load device 903 coupled to a power supply 901 in accordance with another embodiment. The system described in FIG. 9A is more detailed than the system described in FIG. 3. Similar to the power supply 300 of FIG. 3, the power supply 901 includes an AC to DC converter 906 for receiving a voltage from an AC source 902 and converting the AC voltage to DC voltage for use by devices coupled to ports 914A-N, such as load device 903. The power supply 901 also includes DC to DC converters 908A-N for each respective port 914 to service a correspondingly connected device such as load device 903. The DC/DC converter 908 supplies voltage to respectively connected devices such as load device 903 on power line 926. In some embodiments, the DC/DC converter 908 may supply different voltages from device to device or make adjustments to provide varying voltages to the same device depending on power requirements or changes to the power requirements. In some embodiments, the DC/DC converter 908 may provide a legacy fixed voltage to supply a fixed voltage to load device 903 when the load device 903 is a legacy device. In some embodiments, the DC/DC converter 908 may provide a predetermined bias voltage 911 on the communication line 912, which may be provided over the communication line 922 for the power management block (PMB) 927 to generate bias power for activating the microprocessor 932.

In some embodiments, the power supply 901 includes a power & communication circuitry 904 for programming and regulating the power supply 901 and receiving information about the one or more connected devices. Generally, as in the power supply 300 of FIG. 3, these are digitally controlled power sources that can provide adjustable output values, e.g., voltage or current, through the use of a feedback system via a communication line 912. The communication line 912 communicates to connected devices by sending and receiving power requirement information. The power & communication circuitry 904 sends and receives digital communication from devices such as load device 903 via the communication line 912. The power & communication circuitry 904 receives and processes digital messages from the load device 903. The power & communication circuitry 904 is also coupled to the DC/DC converters 908 via electrical bus 910 to configure the DC/DC converters 908 and make adjustments to the supplied power. The power & communication circuitry 904 may include microprocessors, memory, power supply hub and other components (not shown) for storing and processing values, feedback information and instructions to configure the power supply 901. In some embodiments, the processing of a digital message from a load device 903 includes error detection, inspecting the contents of the message, and based on the contents, execute further instructions. Based on the content of the messages, the power & communication circuitry 904 executes instructions to send responses to the load devices 903 via the communication line 912 and/or provide voltage or current values to program the DC/DC converters 908 via electrical bus 910.

In some embodiments, the power & communication circuitry 904 includes circuitry, such as the power supply hub 501 circuitry of FIGS. 5A-D, FIGS. 6A-C to generate bias power that can be provided on the communication line 912. As previously described, the bias power can be utilized to activate a microprocessor 932 on the load device 903 before the rest of the load device 903 is powered up to determine initial power requirements of the load device 903. In some embodiments, the power & communication circuitry 904 can also engage the load device 903 in power saving modes and conserve power when the load device 903 is connected or disconnected to the power supply 901 in accordance with embodiments previously described.

In some embodiments, the power & communication circuitry 904 includes a sense detection mode, which detects the connection or disconnection of the load device 903, for example, as described by the operation of the comparator 616 of FIG. 6. In some embodiments, the power & communication circuitry 904 includes a communicate mode during which data is transmitted and received on communication line 912, and subsequently on communication line 922 to and from the load device 903. In some embodiments, the power & communication circuitry 904 also includes the power injection mode, which allows for the current, and hence a bias voltage, to be provided by the bias power source 339 of FIG. 3 or the DC/DC converter 908 along the communication line 912, 922. In some embodiments, the bias voltage may be provided by any circuit capable of providing a small current or voltage over communication line 912, 922.

In some embodiments, the power & communication circuitry 904 includes memory (not shown) to store a database of predefined power profiles. A power profile is a predefined set of data that specifies power requirements, or more particularly, a predefined combination of power requirement parameters. In some embodiments, a power profile includes one or more of the following: a constant voltage value, a constant current value, a wattage value, an upper limit current value, and a battery type. The power profiles may be organized as a lookup table in memory, with each power profile referenced by an identifier. A device such as load device 903 may communicate, in a digital message, the identifier of the desired profile to the power & communication circuitry 904. The power & communication circuitry 904 retrieves from memory the power profile corresponding to the identifier provided by the load device 903. Parameters in the retrieved power profile are used to configure the power supply 901.

In some embodiments, the load device 903 is coupled to the power supply 901 by a thin wire 924 having connectors to connect to the power supply port 914A and a device port 928. The connecting thin wire 924 includes the power lines 926 and a single communication line 922. The communication line 922 allows for the exchange of information between the communication line 912 of the power supply 901 and a communication line 925 of the load device 903. In some embodiments, bias power may be provided by the power & communication circuitry 904 over the communication lines 912, 922, 925 to activate the microprocessor 932 before the load device 903 is fully powered.

The load device 903 may be any one of the load devices 802A-D of FIGS. 8A-D. In some embodiments, the load device 903 includes a hub interface 930 housing the microprocessor 932 and any other components utilized to interface with the AC source 902 through device port 928. As described in previous embodiments, the microprocessor 932 may include the circuitry of the load device 530, 630, 633 of FIGS. 5A-D and 6A-C and configured to be activated before the load device 903 is powered by receiving bias power from the power supply 901 over the communication line 922, 925. Once the power requirements of the load device 903 are determined, the proper power is configured on the power lines 926 to fully power the load device 903. In some embodiments, the load device 903 includes a load sub-device 940, which may be a separate load processor as described in previous embodiments, which communicates with the microprocessor 932 via communication line 934. In some embodiments, the microprocessor 932 is powered by the bias power over the communication line 922, 925 and the load sub-device 940 is powered when the load device 903 is fully powered. In some embodiments, the load sub-device 940 disables the microprocessor 932 upon being fully powered to avoid conflicting operations. In some embodiments, the microprocessor 932 is activated and the load sub-device 940 is disabled during, for example, power saving modes. In some embodiments, the microprocessor 932 and the load sub-device 940 each have separate functionality for the load device 903 and may operate simultaneously once the load device 903 is fully powered.

FIG. 9B is a block diagram illustrating a load device 903 coupled to a single port power supply 950 in accordance with another embodiment. Some of the same circuit elements in FIG. 9A are included in FIG. 9B, and share the same reference numbers. In the interest of brevity, the descriptions of these same circuit elements are not repeated. In contrast to FIG. 9A, the power processor 905 in FIG. 9B services a single load device at a single connection port 914. In some embodiments, power lines 958 of the AC/DC converter 906 are also provided to the load device 903 via port 914 to provide DC power converted from received AC power from AC source 902. The power supply 950 additionally includes an isolation communication block 956 that allows the power processor 905 to establish isolation boundaries in the power supply 950 circuitry where divisions of high and low voltage domains exist. The isolation communication block 956 facilitates transmissions on communication lines 912 across isolation boundaries between high and low voltage domains of the power processor 905 or the power supply 950 via communication component 954.

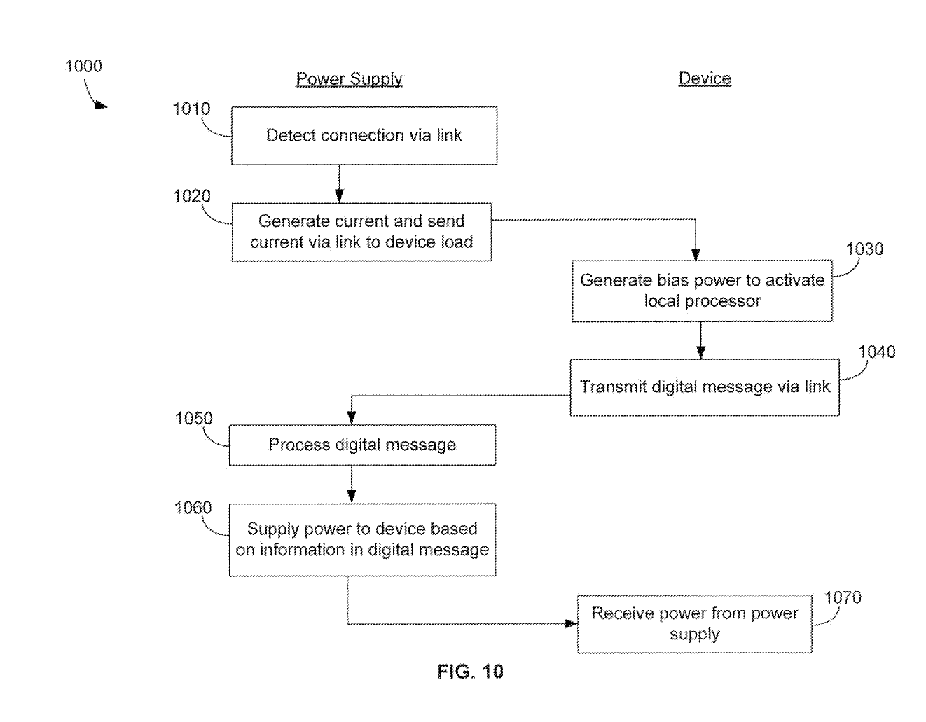

FIG. 10 is a flow diagram illustrating a process 1000 of supplying power by a power supply to a connected device in accordance with some embodiments. Upon detecting a connection via a communication link at step 1010, current is generated by the power supply at step 1020 and provided to the device load over the communication link. At the device, at step 1030, bias power is generated from the current provided by the power supply. The bias power is utilized to activate a local processor. At step 1040, the local processor transmits a digital message via the communication link that includes the power requirements of the device. The power supply processes the digital message at step 1050 and supplies power to the device based on the information in the digital message at step 1060. The device is fully powered upon receiving the power from the power supply at step 1070.

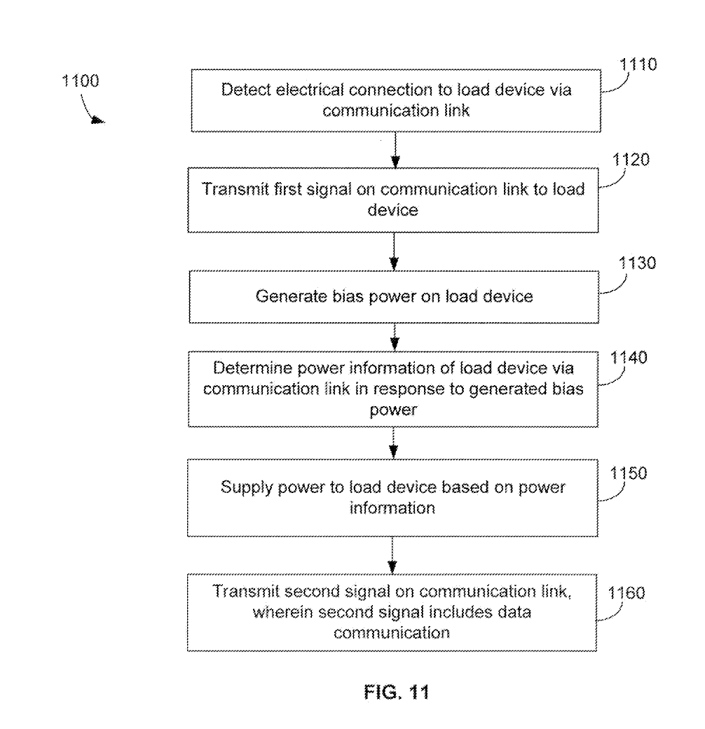

FIG. 11 is a flow diagram illustrating a process 1100 of supplying power by a power supply to a connected device in accordance with other embodiments. At step 1110 an electrical connection to the load device is detected on a communication link. At step 1120, a first signal is transmitted on the communication link to the load device, wherein the load device is powered down. In response to transmitting the first signal, at step 1130, bias power is generated on the load device. At step 1140, power information, such as the power requirements of the load device, is communicated via the communication link and determined once the bias power is generated. Power is supplied to power-up the load device based on the power information of the load device at step 1150. At step 1160, a second signal is transmitted on the communication link, wherein the second signal includes a data communication.

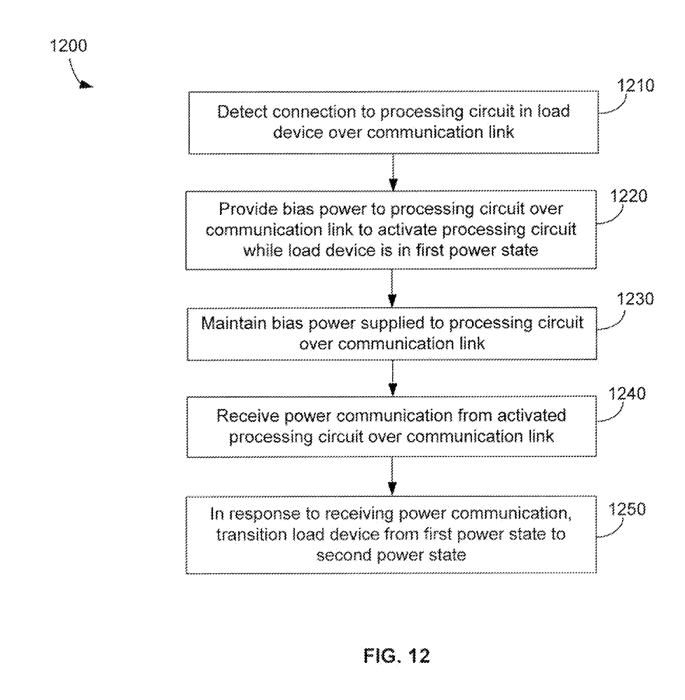

FIG. 12 is a flow diagram illustrating a process 1200 of supplying power by a power supply to a connected device in accordance with some other embodiments. At a step 1210, a connection is detected to a processing circuit in the load device on a communication link. At step 1220, bias power is provided to the processing circuit over the communication link to activate the processing circuit while the load device is in a first power state. The bias power supplied to the processing circuit is maintained over the communication link at step 1230. At step 1240, power communication is received from the activated processing circuit over the communication link. In response to receiving the power communication, at step 1250, the load device is transitioned from the first power state to a second power state.

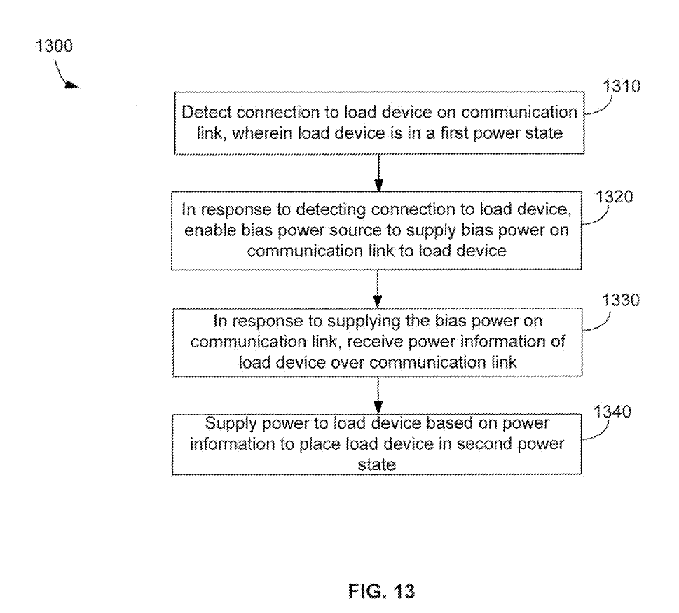

FIG. 13 is a flow diagram illustrating a process 1300 for connecting a power supply to a load device in accordance with some other embodiments. At step 1310, a connection to the load device is detected on a communication link, wherein the load device is in a first power state. In response to detecting the connection to the load device, at step 1320, a bias power source is enabled to supply bias power on the communication link to the load device. In response to supplying the bias power on the communication link, at step 1330, power information of load device is received over the communication link. At step 1340, power to the load device is supplied, based on the received power information, to place the load device in a second power state. The main power to the load device is supplied via power lines.

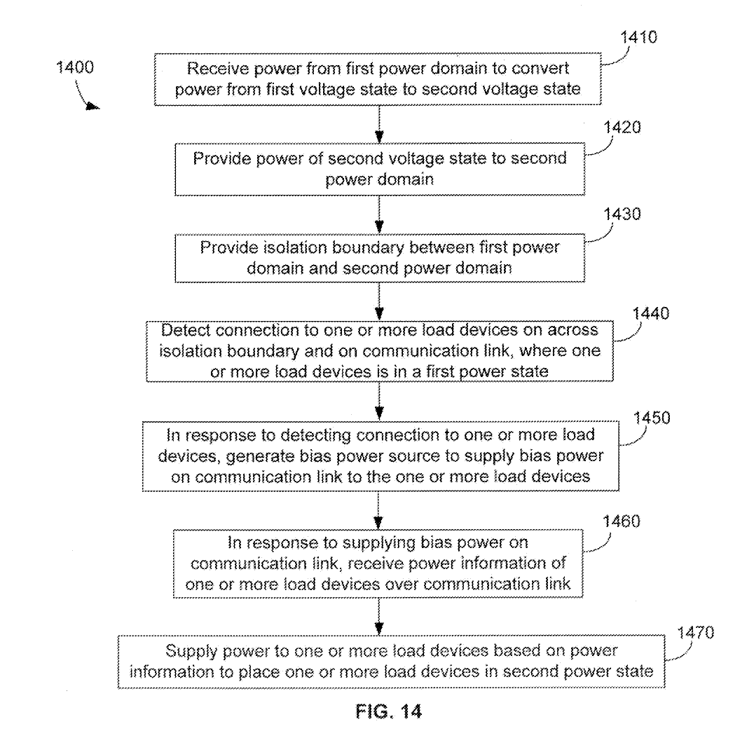

FIG. 14 is a flow diagram illustrating a process 1400 for providing power to one or more load devices. At step 1410, power from a first power domain is received to convert the power from a first voltage state to a second voltage state. At step 1420, power of the second voltage state is provided to a second power domain. At step 1430, an isolation boundary between the first power domain and the second power domain is provided. A connection to the one or more load devices is detected, at step 1440, across the isolation boundary and on a communication link, wherein the one or more load devices is in a first power state. In response to detecting the connection to the one or more load devices, at step 1450, bias power is generated and supplied on the communication link to the one or more load devices. In response to supplying the bias power on the communication link, at step 1460, power information is received of the one or more load devices over the communication link. At step 1470, power to the one or more load devices is supplied, based on the power information, to place the one or more load devices in a second power state. The main power to the one or more load devices is supplied via power lines.

According to some embodiments, upon detecting a connection between a power supply and a load device via a communication link, current is generated by the power supply and provided to the load device over the communication link. At the load device, bias power is generated from the current provided by the power supply. The bias power is utilized to activate a local processor. The local processor transmits a digital message via the communication link that includes the power requirements of the load device. The power supply processes the digital message and supplies power to the load device based on the information in the digital message. The load device is fully powered upon receiving the power from the power supply.

According to some embodiments, an electrical connection to the load device is detected on a communication link. A first signal is transmitted on the communication link to the load device, wherein the load device is powered down. In response to transmitting the first signal, bias power is generated on the load device. Power information of the load device is communicated via the communication link and determined once the bias power is generated. Power is supplied to power-up the load device based on the power information of the load device. A second signal is transmitted on the communication link, wherein the second signal includes a data communication.

According to some embodiments, a connection is detected by a power supply to a processing circuit of a load device over a communication link. Bias power is provided to the processing circuit on the communication link to activate the processing circuit while the load device is in a first power state. The bias power supplied to the processing circuit is maintained over the communication link. Power communication is received from the activated processing circuit over the communication link. In response to receiving the power communication, the load device is transitioned from the first power state to a second power state.

According to certain embodiments, a method for providing power to a load device comprises detecting a connection to the load device on a data transmission line and supplying bias power to the load device on the data transmission line. In response to supplying bias power to the load device, the method further comprises receiving power information of the load device on the data transmission line, and configuring power to provide to the load device based on the received power information. According to certain embodiments, the method further comprises detecting the load device disconnecting on the data transmission line, and in response to the load device disconnecting, disabling the bias power to the load device and disabling the power supplied to the load device. According to one aspect, supplying a bias power to the load device on the data transmission line comprises bootstrapping a load processor on the load device to activate the load processor while the load device is in an inactive mode.

According to certain embodiments, a power supply to provide power to a load device comprises a communication line, a processor coupled to the communication line, the processor configured to receive data on the communication line, a sense circuit coupled to the communication line, the sense circuit configured to detect whether the load device is connected to the communication line and operable to provide a control signal based on the detection, and a bias power source coupled to the communication line, the bias power source configured to receive the control signal from the sense circuit and operable to provide bias power to the load device, wherein the load device transmits power information of the load in response to receiving bias power. According to one aspect, the load device further comprises a load processor coupled to the communication line, the load processor being activated in response to the load device receiving bias power on the communication line, and being operable to transmit power information of the load device on the communication line. According to another aspect, the load processor is activated in response to the load device while the load device in an inactive state. According to another aspect, the bias power source comprises a current source. According to another aspect, the current source comprises at least two transistors in a current mirror configuration and, in response to receiving the control signal from the sense circuit, operable to generate current to provide to the communication line. According to another aspect, the sense circuit comprises a comparator circuit having an output node, a first input node coupled to the communication line, and a second input node coupled to a reference voltage, the comparator circuit being operable to generate a control signal at the output node in response to comparing a signal received at the first input node to the reference voltage. According to another aspect, the reference voltage is further coupled to the output node of the comparator circuit in a feedback configuration. According to another aspect, the sense circuit comprises at least one transistor coupled between a voltage potential and ground, the at least one transistor comprising an emitter coupled to an output node, a base coupled to an input node being further coupled to the communication line, the at least one transistor providing a first control signal in response to the load device connecting and a second control signal in response to the load device disconnecting. According to another aspect, the first and second control signals are provided to the processor.

According to certain embodiments, a power supply to provide power to a load device comprises a communication line, a processor coupled to the communication line, the processor configured to receive data on the communication line, a sense circuit coupled to the communication line, the sense circuit configured to detect whether the load device is connected to the communication line and operable to provide a control signal based on the detection, a bias power source coupled to the communication line, the bias power source configured to receive the control signal from the sense circuit and operable to provide bias power to the load device, wherein the load device transmits power information of the load in response to receiving bias power, and isolation circuitry coupled to the communication line, the isolation circuitry configured to provide at least one isolation boundary between a high voltage domain and a low voltage domain, wherein communications to and from the load device are transmitted on the communication line across the isolation boundary. According to one aspect, the isolation circuitry provides an isolation boundary between a high voltage domain and a low voltage domain of at least one of the processor, sense circuit and bias power source. According to another aspect, the isolation circuitry comprises one or more of: a transformer, an optocoupler device, and a proximity detector. According to another aspect, the isolation boundary between the high voltage domain and low voltage domain of the at least one processor comprises a transformer device coupled to the communication line. According to another aspect, data received by the processor is transmitted across the transformer by a first driver circuit of the load device and an inverted buffer of the processor; and data is transmitted from the processor across the transformer by a second driver circuit of the processor and an inverted buffer of the load device. According to another aspect, the sense circuit is controlled in the high voltage domain and the isolation circuitry including an optocoupler to provide an isolation boundary from the sense circuit on the communication line. According to another aspect, the sense circuit is further coupled to a driver circuit coupled to the communication line, the driver circuit operable to detect a connection of a load device and drive a detect signal across the isolation boundary from the sense circuit to provide the detect signal to the sense circuit. According to another aspect, the bias power source comprises an auxiliary power source, the auxiliary power source being controlled in the high voltage domain and the isolation circuitry including a transformer to provide an isolation boundary from the auxiliary power source on the communication line.

According to certain embodiments, a power supply hub comprises a processor having a first power domain and a second power domain, wherein power the first power domain is associated with high voltage and the power in the second power domain is associated with low voltage. The power supply hub further comprises isolation circuitry coupled to the processor and to a communication line, the isolation circuitry including at least one isolation device and being configured to provide at least one isolation boundary between the first power domain and the second power domain. The power supply hub further comprises a port connector coupled to the isolation circuitry via the communication line, the port connector configured to connect the power supply hub to a load device. The power supply hub further comprises a communication component associated with the processor, the isolation circuitry, and the port connector via the communication line, the communication component operable to control transmission of one or more signals to and from the processor and the port connector across the isolation boundary provided by the isolation circuitry. According to one aspect, the power supply hub further comprises a bias power circuit coupled to the processor and operable to generate bias power, wherein the communication component applies the generated bias power on the communication line. According to another aspect, the power supply hub further comprises an AC/DC power converter coupled to the processor, the AC/DC power converter operable convert AC power to DC power. According to another aspect, the AC/DC power converter comprises a diode bridge, the diode bridge being operable to convert an AC signal to a DC signal. According to another aspect, the power supply hub further comprises a power factor correction circuit as another power source and for making adjustments to the supplied power. According to another aspect, the power supply hub further comprises an isolation feedback circuit coupled to the processor and the AC/DC power converter, the isolation feedback circuit being operable to provide feedback from power supply by the AC/DC power converter to the processor, and to control an output of power from the second power domain delivered to the port connector. According to another aspect, the port connector comprises a wireless connector port. According to another aspect, the isolation circuitry further comprises communication circuitry configured to enable the transmission of the one or more signals across the isolation boundary. According to another aspect, the communication component is further configured to control the transmission of one or more signals in energy-saving communication transmissions via the communication line.

According to certain embodiments, a power supply hub comprises a first processor having a first power domain, operable to control one or more high voltage operations including converting a high voltage state to a low voltage state, wherein power of the first power domain is associated with high voltage. The power supply hub further comprises a second processor having a second domain, the second processor coupled to a first communication line, and operable to control one or more low voltage operations including the operation of supplying power at a low voltage state, and wherein the power of the second power domain is associated with low voltage. The power supply hub further comprises isolation circuitry coupled between the first processor and the second processor via a second communication line, the isolation circuitry including at least one isolation device and configured to provide an isolation boundary between the first power domain of the first processor and the second power domain of the second processor. The power supply hub further comprises a port connector coupled to the second processor via the first communication line, the power connector configured to supply the power at the low voltage state. The power supply hub further comprises a first communication component associated with the first processor, the first communication component being operable to control the transmission of one or more signals across the isolation boundary via the first communication link. The power supply hub further comprises a second communication component associated with the second processor, the second communication component being operable to control the transmission of one or more signals across the isolation boundary via the first communication link and between the second processor and the port connector via the second communication link. According to one aspect, the first and second communication components are further configured to control the transmission of one or more signals in energy-saving communication transmissions via the communication line. According to another aspect, the second processor comprises a plurality of port connectors configured to connect one or more load devices to the supply hub, and operable to supply power to the one or more connected load devices.

According to certain embodiments, a power supply hub comprises a first processor configured to have a first power domain and operable to control one or more operations in a first voltage state. The power supply hub further comprises a plurality of second processors, each configured to have a second power domain and operable to control one or more operations in a second voltage state. The power supply hub further comprises an isolation communication system coupled between the first processor and the plurality of second processors, the isolation circuitry including at least one isolation device and configured to provide an isolation boundary between the first processor and the plurality of second processors via at least one first communication link. The power supply hub further comprises a plurality of communication components associated with a respective second processor and the isolation communication system, the plurality of communication components being operable to control the transmission of one or more signals across the isolation boundary of the isolation communication system via the at least one first communication link and control one or more transmissions to at least one port connector via at least one second communication link. According to one aspect, the isolation communication system comprising a plurality of isolation devices, each of the isolation devices associated with a respective second processor. According to another aspect, the plurality of second processors coupled to a plurality of connectors are configured to connect to one or more load devices via the second communication link, and operable to supply power to the one or more connected load devices.

According to certain embodiments, a load device for connecting to a power supply, comprises a communication line coupled to a connector, the communication line configured to send and receive data transmissions. The load device further comprising a power line coupled to the connector, the power line configured to receive main power supplied to the load device. The load device further comprising at least one load processor coupled to the power line; and a power management component configured to associate with the communication line and the at least one load processor, the power management component configured to receive bias power on the communication line and operable to supply the bias power to the at least one load processor, wherein the bias power activates the at least one load processor to a first power state, and wherein the at least one load processor provides power information to the power management component for transmitting on the communication line. According to one aspect, the at least one load processor, in response to transmitting the power information on the communication line, receives main power at the power line to transition the at least one load processor to a second power state. According to another aspect, the at least one load processor comprises a first load processor configured to associate with the power management component and receive the bias power, and a second load processor configured to associate with the power line and receive the main power. According to another aspect, the first load processor is a bootstrap processor, wherein the bootstrap processor operates at a power level that is less than the second load processor, and wherein the bootstrap processor is operable to provide the power information of the load device on the communication line. According to another aspect, the bootstrap processor functions at a low power mode while the load device is at least in a group consisting of: an inactive mode, a sleep mode, and a standby mode. According to another aspect, the first load processor is a microprocessor. According to another aspect, the power management component is integrated in the at least one load processor. According to another aspect, the load device further comprises a sense circuit coupled to the communication line, the sense circuit configured to detect the electrical connection to the load device at the connector.

According to certain embodiments, a method for providing power to a load device comprises detecting a connection to a transmission line for sending and receiving data transmissions. The method further comprising receiving bias power on the transmission line and in response to receiving the bias power, activating at least one load processor a first power state. The method further comprising, in response to activating the at least one load processor, providing power information on the transmission line. According to another aspect, in response to providing power information on the transmission line, connecting to a power line for receiving main power supplied to the load device and receiving the main power supplied on the power line.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A system for connecting to a load device, comprising:
a communication line for transmitting data information to and from the load device;
a bias power source coupled to the communication line and configured to supply bias power on the communication line, the bias power source operable to activate a communication device on the load device, wherein the load device is in a first power state; and
a processing unit coupled to the communication line, the processing unit configured to receive power information from the communication device of the load device to place the load device in a second power state based on the received power information.

2. The system of claim 1, further comprising a detecting unit coupled to the communication line, the detecting unit operable to detect if the load device is connected to the communication line.

3. The system of claim 2, wherein the detecting unit comprises a comparator having an input node coupled to the communication line and output node coupled to the processing unit, the comparator being operable to provide a control signal to the processing unit in response to receiving an input signal at the input node and comparing the input signal to a reference voltage.

4. The system of claim 2, wherein the detecting unit comprises a transistor having a base coupled to the communication line and a collector coupled to the processing unit, the transistor being operable to receive an input signal at the base and provide a detect signal to the processing unit in response to receiving the input signal.

5. The system of claim 1, wherein the bias power source comprises a current source operable to supply bias current to the communication line.

6. The system of claim 1, wherein the bias power source comprises a magnetic device operable to store energy when the load device is in a second power state and supply energy to the communication line when the load device is in the first power state.

7. The system of claim 1, wherein the communication device on the load device comprises a processing unit on the load device configured to provide power information on the communication line in response to the communication device being activated by the bias power source.

8. The system of claim 1, wherein the first power state is a device sleep mode and the second power state is a device on mode.

9. A method for connecting to a load device, comprising:
detecting a connection to the load device on a communication link, wherein the load device is in a first power state;
in response to detecting the connection to the load device, enabling a bias power source to supply bias power on the communication link to the load device;
in response to supplying the bias power on the communication link, receiving power information of load device over the communication link; and
supplying power to the load device based on the power information to place the load device in a second power state.

10. The method of claim 9, further comprising detecting disconnection of the load device on the communication link, and in response to detecting disconnection, disabling the bias power source from supplying the bias power on the communication link.

11. The method of claim 9, wherein detecting the connection to the load device further comprises:
receiving an input signal from the communication link;
comparing the input signal to a reference signal; and
generating a detect control signal based on the comparison.

12. The method of claim 9, wherein enabling the bias power source comprises generating a current from a current source.

13. The method of claim 9, wherein enabling the bias power source comprises storing energy on a magnetic device and supplying power from the stored energy on the communication link.

14. The method of claim 9, wherein the first power state is a sleep mode and the second power state is a device on mode.

15. A method for providing power to one or more load devices, comprising:
receiving power from a first power domain to convert the power from a first voltage state to a second voltage state;
providing the power of the second voltage state to a second power domain;
providing an isolation boundary between the first power domain and the second power domain;
detecting a connection to the one or more load devices across the isolation boundary and on a communication link, wherein the one or more load devices is in a first power state;
in response to detecting the connection to the one or more load devices, generating bias power and supplying the bias power on the communication link to the one or more load devices;
in response to supplying the bias power on the communication link, receiving power information of the one or more load devices over the communication link; and
supplying power to the one or more load devices based on the power information to place the one or more load devices in a second power state.

16. The method of claim 15, wherein supplying the bias power on the communication link comprises supplying the bias power on the communication link across the isolation boundary.

17. The method of claim 15, wherein receiving power from the first power domain comprises receiving power from an AC voltage source.

18. The method of claim 17, wherein converting from a first voltage state to a second voltage state comprises converting from the AC voltage source to a DC voltage source.

19. The method of claim 15, wherein the isolation boundary is provided by isolation devices coupled to the communication link.

20. The method of claim 15, wherein supplying power to the one or more load devices comprises supplying power to a single load device at a single port.

21. The method of claim 15,
wherein converting from a first voltage state to a second voltage state further comprises providing controls by a first processor,
wherein providing voltage of the second voltage state in the second power domain comprises providing controls by at least a second processor, and
wherein providing an isolation boundary between the first power domain and the second power domain comprises providing an isolation boundary between the first processor and the at least the second processor.

22. The method of claim 21, wherein supplying power to the one or more load devices comprises supply power to a plurality of devices at a plurality of ports connected to the at least second processor.
